(19) United States
(12) Patent Application Publication
(10) Pub. No.: US 2023/0356490 A1
(43) Pub. Date: Nov. 9, 2023

(54) COMPOSITE WHEEL ASSEMBLIES

(71) Applicant: Delta Wheels, LLC, Orchard Lake, MI (US)

(72) Inventors: Armin von Czarnowski, Orchard Lake, MI (US); Peter von Czarnowski, Orchard Lake, MI (US); Dirk Uffelmann, Ering (DE)

(21) Appl. No.: 18/184,484

(22) Filed: Mar. 15, 2023

Related U.S. Application Data
(60) Provisional application No. 63/320,109, filed on Mar. 15, 2022.

(51) Int. Cl. B60B 5/02; B29D 99/00; B60B 3/10; B60B 23/06

(52) U.S. Cl. CPC B29D 99/0032; B60B 3/10; B60B 5/02; B60B 23/06; B60B 2360/10; B60B 2360/3412; B60B 2360/3416; B60B 2900/111; B60B 2900/1216

(57) ABSTRACT

Methods for fabricating composite wheel assemblies are described, as well as the composite wheel assemblies being fabricated. The composite wheel assemblies may include multiple formed components that are joined together at one or multiple locations within the wheel assemblies, or may be fabricated as a castable wheel. The composite wheel assemblies may be fabricated from reinforced plastic and/or a metal.

### CROSS-REFERENCE TO RELATED APPLICATIONS

The present application claims the benefits of U.S. Provisional Application Serial No. 63/320,109, filed Mar. 15, 2022, entitled “Composite Wheel Assemblies”, which is incorporated herein by this reference in its entirety.

### FIELD

The present disclosure relates generally to wheel structures and, in particular, to the aesthetic design, cost reduction in manufacturing, and appropriate material selection for wheel structures including the use of fiber-reinforced composites.

### BACKGROUND

Known methods of producing high-performance wheels (e.g., such as those used for electric vehicles) involves the use of forgings or flow-forming of casted pre-forms. To achieve low drag resistance, the wheel disc needs to be almost completely closed, with brake cooling holes taking up preferably less than 40% of the disc surface area. These “aero wheels” are specialized wheels designed to improve the aerodynamics of a vehicle, thus reducing air drag and increasing fuel efficiency or driving range for EVs. The partially closed center used for wheels such as those installed on electric vehicles is not suitable for light metal wheel designs, which typically adhere to manufacturing methods such as casting and forging. When closed wheel discs are made through forging or casting methods using a conventional monolithic spoke layout, they can significantly increase the weight of the wheel. Adding an aerodynamic cap to a conventional wheel to create a closed disc can also result in increased weight, without contributing to the structural integrity, and can often be associated with lower quality perception.

To compensate for the added weight of a large aero wheel disc, manufacturers often turn to carbon fiber reinforced plastic (CFRP) wheels, which can be costly to develop, validate, manufacture, and repair. However, known methods of manufacturing CFRP wheels also currently follow the above-described industry design preferences.

### SUMMARY

The invention described in the present disclosure offers a solution for the cost-efficient and safe production of CFRP wheels, particularly for the design of lightweight aero wheels. In particular, the invention described in the present disclosure may be utilized for electric vehicles (EVs). This innovation has the potential to significantly reduce the cost associated with CFRP wheels while still maintaining high levels of safety and performance. This is achieved by separating the 3-dimensional spoke structure or heavy monolithic disc (as shown in the prior art illustrated in FIG. 1) into multiple separate non-planar components as shown in FIG. 2 directed to the present invention. The separated non-planar disc members create distinct aesthetics and enable the use of highly automated manufacturing methods and manufacturing sequences that are not currently applied in wheel manufacturing. In embodiments, the non-planar disc members form a load-bearing “cone-like” hollow structure in which the outer cone can be concave or convex in relation to the rotational plane of the wheel.

The following definitions are used throughout the present disclosure. A rim is the outer edge of the wheel that holds the tire. Spokes are rods made from metal or CFRP that connect the rim to the hub. A hub is the central part of the wheel that connects to the axle. Lug nuts are the nuts that attach the wheel to the hub. A valve stem is the stem through which air is added or removed from the tire. A center cap is the decorative cover that hides the hub and lug nuts. Wheel studs are the bolts that hold the wheel to the hub. It is noted that different terms may be used for wheel center (e.g., spoke, disc, disc-member, member, or the like). It should be understood that all of these terms refer to the wheel center, without departing from the scope of the present disclosure. For example, spoke is used as a term if the wheel center is relatively open (e.g., for good ventilation or preferred design), whereas disc is used for a wheel center with relatively small cutouts (e.g., for low drag resistance).

The invention described in the present disclosure includes various specific features aimed at improving the usability, ease of maintenance, maximum safety of a CRFP wheel, while reducing manufacturing costs for full CFRP wheels and hybrid wheels made of CRFP and metal. In some embodiments, the improvements described in the present disclosure enable the development of CFRP solutions or metal-CFRP hybrid solutions. The disclosure describes new combinations of various semi-finished materials such as CFRP, forgings, castings, or sheet metals that are used to form hybrid multi-material wheels. These multi-material solutions require specific joining and manufacturing processes, which are described throughout the present disclosure.

The disclosure also describes specific features to enhance the usability and effectiveness of the bi-planar structures in wheel configurations described herein.

In embodiments, the spoke structure can accommodate a wheel cap to balance the load distribution, enhance aerodynamics, and provide additional aesthetic features. The wheel cap may be an integral part of the load-bearing structure. In embodiments, the spoke structure can be integrated into an injection molding process. This allows the spoke structure to provide the necessary structural integrity while the injection molded component addresses design requirements, active cooling features, and low drag resistance.

In embodiments, the present disclosure is directed to wheel assemblies including one or multiple components fabricated from a reinforced plastic (e.g., carbon fiber reinforced plastics, or other reinforced plastics as described throughout the present disclosure) or fabricated from a metal, with any combination of reinforced plastics and metal components being possible for the wheel assembly.

Embodiments of the present disclosure are directed to a wheel-disc made from prefabricated reinforced plastic sheets, preferably CFRP to be integrated in a conventional rim made from CFRP or metal materials, or integrated in a metal sub-structure to meet the load requirement of the wheel. Instead of long CFRP, non-continuous carbon fiber CF-SMC can be used. Non-continuous carbon fiber sheet molding compound (CF-SMC) is a composite material that consists of short carbon fibers and a resin.

Embodiments of the present disclosure are directed to the use of a wheel disc made from prefabricated reinforced plastic sheets, preferably CFRP. This disc can be integrated into a conventional rim made from CFRP or metals or alternatively into a metal sub-structure to meet the load requirements of the wheel. It is noted that this metal sub-structure may be described as Backbone or Frontbone in the present disclosure. In other embodiments, short discontinuous fiber CF-SMC and/or long discontinuous fiber CF-SMC can be used instead of continuous CFRP.

In some embodiments, the two disc members made from prefabricated CFRP sheets are arranged in a way that minimizes bending forces and optimizes load distribution. The radial cross-section preferably consists of triangular elements, but it can also be in the form of a polygon for packaging reasons. By arranging the disc members in this manner, the load-bearing capacity of the wheel can be improved while reducing weight and production costs.

In some embodiments, the wheel sub-structure (backbone/frontbone) can be made in one or multiple parts from cast, forged, extruded, or sheet metal. An advanced casting or forging can be used for the wheel substructure to integrate maximum features for mounting purposes, crash performance, or special load cases. The substructure, along with the curb-side disc component, forms a triangle of the wheel structures described herein. In embodiments, the present disclosure describes frontbone or backbone designs as options for constructing aerodynamic wheels, wheels with narrow spokes, or in-wheel drive solutions.

It is noted that when an advanced casting or other materials are used for the wheel substructure, the triangular build of the wheel structures described herein can already be included. This “one-piece-wheel” allows for the use of a simplified curb-side component to manufacture aero wheels. The tools used to cast the substructure can be segmented to reduce manufacturing costs for various design variants and dimensional modifications.

In embodiments of the present disclosure, the overall manufacturing process for a CFRP wheel is divided into sub-processes to ensure good accessibility. Each process step may have individual tooling and separate or shared working space. This superior accessibility allows for a high degree of automation, with a target of over 50%, and preferably over 75%. In contrast, conventional manufacturing is performed as a complex procedure laying up the entire wheel as a monoblock. By dividing the manufacturing process into separate sub-processes, the manufacturing of CFRP wheels can be made more efficient and cost-effective. With a higher degree of automation, the production process can also be more consistent, with less risk of errors or defects.

In some examples, the overall manufacturing process for a CFRP wheel structure as described herein generally involves dividing the process into three components processed in up to 10 workspaces. This allows for a more efficient and streamlined manufacturing process, with each component being processed separately for greater accessibility and ease of manufacturing. In other examples, the sub-components of the CFRP wheel structures described herein can be cured as individual components before final assembly. This allows for greater control and accuracy in the curing process. In other examples, the individual manufactured components of the CFRP wheel will be integrated using CFRP lay-ups. Alternatively the rim and the wheel center-discs can be mounted with mechanical joining methods.

It is noted that the overall manufacturing process for CFRP wheel structures described herein may be divided in sub-processes to achieve an automatization >90% utilizing CFRP components processed separately.

In some embodiments, the prefabricated CFRP sheets can be in flat or curved form and may contain formed elements or additional lay-ups. This allows for greater flexibility in the manufacturing process, as well as improved accuracy and quality in the finished product.

In some embodiments, the entire wheel can be made from reinforced plastic material, preferably in bi-planar shaped disc/spoke geometry, using prefabricated CFRP or layered patches. The number of layers can be reduced to decrease production time and cost while maintaining the desired strength and structural integrity.

In some embodiments, the invention includes a fiber layout that is anisotropic and nonhomogeneous in fiber resin ratio. By locally orienting fibers in the principal axis of the spoke a higher local tensile and compressive modulus in the principal axis can be achieved. Stress concentrations are moved from the radius to a location internal of the spoke. This allows for more aesthetic design freedom of the wheel center as the radii do not have to be designed according to stress distributions.

It is noted that the wheel-center-structure made from two disc members inherently allows reduced manufacturing time, automatization and reduced product development validation and better prediction of mechanical properties by Finite Element Method (FEM) modelling. CFRP wheels with complex spoke geometries often have sharp radii, which can be difficult to model accurately in FEM simulations. Therefore, the use of two flat disc members for the wheel-center design can significantly reduce the development cost and time, which is critical in the competitive automotive industry to bring new designs to the market in a timely manner. The reduced manufacturing time is due to the fact that a conventionally applied complex spoke geometry is replaced by two relatively flat shaped components with good accessibility.

Finally, the wheel-center-structure design that uses two disc-members instead of a complex spoke geometry can simplify and automate the manufacturing process, reduce production time and cost, and improve efficiency. The relatively flat shape of the two components allows for better accessibility during manufacturing and assembly, resulting in a more streamlined and efficient process. being able to apply a more reliable simulation, helps to predict the mechanical properties of the wheel-center-structure, leading to a more reliable and long-lasting wheel design.

The material used for the wheel structures described herein can be, but is not limited to, aluminum, magnesium, specialty steel, reinforced composites, carbon fiber reinforced composites (CFRP), pultrusion materials and laminates of dissimilar materials. A beneficial add-on reinforcement are graphene flakes. For example, the graphene flakes can be used together with conventional carbon fibers to form a CFRP sheet. In some embodiments, subcomponents of the wheel and/or the entire wheel might be made from CFRP. In other embodiments, subcomponents of the wheel might be made from CFRP, and other subcomponents of the wheel might be made from metallic materials like aluminum extrusion, castings, or sheet metal. In other embodiments, the entire wheel might be made from metallic materials like aluminum extrusion, castings, forged, or sheet metal.

Casting methods are described in the present disclosure, in which (a) the metal is kept in the semi-liquid state, (b) under elevated or high pressure, and controlled atmosphere. Those processes lead to superior mechanical properties, better weldability and partially to higher consumption of scrap. For example, in casted components melting treatments can be applied in which high shear stresses are introduced in the melt. This leads to a fine grain structure and increased consumption of scrap material.

In some embodiments, the material thickness might exceed 5 mm, particularly in sheet metal used for the inner or outer disc to meet load and crash requirements. It is contemplated that higher metal thickness is particularly needed for discs with significant cut-outs applied to inner or outer disc element of the wheel. However, the material thickness can be lower than 5 mm, depending on the cut-out geometry, the supporting structure for the center disc, or stiffening features in the disc or spoke, without departing from the scope of the present disclosure. For example, Lower metal thickness is particularly possible for closed discs, respectively closed disc with narrow openings (cut-outs).

Regarding the wheel rim of the present disclosure, the rim of the wheel includes patterns, open formed elements, or cavities to increase the stiffness of the rim with positive effect on the load path or crash performance. Foam may be used to fill the stiffening cavities in the rim to provide an additional level of stiffness, further improving the overall performance of the wheel. Any engineered openings or cavities in in the rim might be filled with an ultra-light media, like an Al-foam. It is contemplated that the full wheel might be produced in a 3-dimensional sandwich structure which is filled with an ultra-light weight media, like an aluminum foam. A sandwich structure design for the rim can achieve the best stiffness-to-weight ratio for the wheel.

In some embodiments, the use of repeating patterns on the rim is beneficial to increase the integral stiffness of the wheel. For example, the hexagonal structure is one preferred repeating pattern for enhancing the stiffness of the rim. To achieve a consistent and uniform design, the repeating pattern can be directly transferred from the tool onto the rim product prior to material forming.

In some embodiments, the wheel can exhibit protective features to avoid damage at the rim. These protective features are preferably an integral element of the curb-side disc. Alternatively, they can be mechanically fastened and can be replaced in case of damage at moderate cost.

Regarding the wheel center of the present disclosure, to ensure that the inner disc/spoke member of the wheel remains intact in the event of a crash, measures are taken to avoid its collapse. These techniques are specifically developed to improve curb impact performance, but also improve other related crash scenarios. The techniques involves incorporating appropriate modifications of the disc contour or apply forming elements that can prevent Euler buckling during crash, side flange impact, and rim impact scenarios.

One contemplated approach is to incorporate a forming element to stiffen the inside spoke-members of the wheel center. These stiffening elements increase the second moment of area of the cross section of the spoke-members. Stiffening the inside spoke-members helps to improve the wheel’s resistance to Euler buckling, which is a crucial factor in ensuring the wheel’s stability in the event of a crash, particularly if the large cut-outs at the vehicle-side disc-member creates narrow inner spokes. In one non-limiting example the stiffening elements may take the form of a bow-shaped spoke member. The bow-shaped inner spoke member serves an important function by providing a distinct deformation path that prevents interference with the brake system in the event of a crash, by essentially causing the inner spoke to deform towards the outside of the wheel and away from the brake system.

Alternatively, the inner spoke can be locally stiffened trough a locally increased thickness of the spoke. This increases the second moment of area of the cross section of the spoke as well as reduces the effective unsupported length as it relates to the mechanics of Euler buckling.

Alternatively, the width of the inner spoke can be increased. This increases the second moment of area of the cross section of the spoke as well as reduces the effective unsupported length as it relates to the mechanics of Euler buckling.

An alternative approach to preventing early Euler buckling is to connect the inner (or vehicle) and outer (or curbside or vehicle-side) spoke-members of the inner wheel structure using various specific methods. The vehicle-side and curb-side spokes of the wheel incorporate forming elements that help connect the vehicle-side and curb-side spokes and therefore stabilize the inner wheel structure in case of crash. In addition, the aesthetic design of the triangular wheel structures described herein is enhanced by the presence of the forming elements that serve a functional purpose by connecting the inner and outer spokes.

To prevent the collapse of the inner and outer spokes due to Euler buckling, a connecting element or transfer structure can be included in the design of the inner wheel structure. This element can be a separate part from the spoke or can be integrated into the spokes through methods such as injection molding and may also include a snap fastening mechanism.

In other embodiments, the inside or inner spokes can be over-molded with low density material to increase crash energy absorption. In other embodiments, a stiff center region within the disc structure that keeps the two legs of the triangle in position, so that the inner-brake-side angle at the rim side does not vary during dynamic load.

In some embodiments, the components of the hybrid CFRP-metal wheel are connected using a mechanical fastening mechanism that includes a screw-plate integrated into the CFRP component. For example, the screw-plate component may include a screw-nut combination. Alternatively, the joining of the rim and center may utilize a different mechanical fastening mechanism. It is contemplated that the screw plate component can serve a dual purpose as both a fastening and rim protection element, helping to minimize the risk of damage to the curb side rim flange.

In some embodiments, the invention includes a geometry of one or more formed and flanged planar sheets to be bonded to the outer rim portion. The flanges of the formed planar sheets form cylinders that are concentric with a specially prepared rim section. The flanges can be of such diameter that an interference fit can be produced between the two flanges as well as the rim hoop. In some embodiments, the bonding is done through adhesives, but is not limited to such. Alternatively, bonding can be achieved through common thermoplastic welding techniques such as vibration welding, spin welding, electrically heated insert welding, or induction welding.

In some embodiments, to prevent the buildup of snow or debris in the narrow end of the triangular space, a wheel element is designed to fill the corner of the triangle. This element is shaped in such a way that any dirt or debris is directed towards the outer edge of the wheel center.

In embodiments, to realize the highly deep-drawn hub in the curb-site center sheet, the blank is modified with slots and/or holes. The modified blank reduces circumferential compressive and tensional stresses during the deep drawing. This allows for a higher deep drawing ratio.

In embodiments, the wheel center design utilizing inside/outside disc-members can be modified to include a ventilation feature. This feature can be integrated into either the inner or outer disc-member, or placed between the inner and outer disc-members as an inter-disc vent-element. For example, the inter-disc ventilation feature or vent element might be formed by injection molding.. For instance, the plastic may be reinforced by glass fibers, carbon fibers, carbon flakes, graphene flakes or graphene-oxide flakes. In some embodiments, to simplify the manufacturing process, the inter-disc vent can be injection molded together with one or more structural elements of the wheel center.

It is noted that to further enhance the structural integrity of the wheel-disc-structure, any free spaces might be filled with an ultra-lightweight material such as foam or plastic members. One example is the triangular area within the wheel center structure. For maximum weight savings, aluminum foam is the preferred choice of material.

In additional embodiments, a fully castable compact wheel structure is also described in an alternative to the distinct multi-component assemblies. This can be advantageous when integrating an in-wheel electric motors that require a significant amount of packaging space inside the rim-drum. The fully castable wheel structure is made as a one-piece component and features the triangle shape in the spoke, which is combined with an I-beam element that complements the triangle. This wheel structure, combining the triangle shape and I-beam geometry for the spokes, build up as a finished wheel may be equipped with CFRP elements to reduce aerodynamic resistance, and/or can be used an intermediate wheel-component combined with other embodiments in the present disclosure.

In some embodiments, the wheel assembly may be coupled to or be partially integrated with in-wheel electric motors installed on the vehicle axle.

In embodiments, the present disclosure is directed to a method for fabricating a wheel assembly. The method includes, but is not limited to, forming an outer disc from a reinforced plastic, wherein the outer disc includes a first plurality of spokes. The method includes, but is not limited to, forming an inner disc from the reinforced plastic, wherein the inner disc includes a second plurality of spokes. The method includes, but is not limited to, forming a rim. The method includes, but is not limited to, forming the wheel assembly from the outer disc, the inner disc, and the rim. The outer disc, the inner disc, and the rim are coupled at a first joining location. The outer disc and the inner disc are coupled at a second joining location. A first spoke of the first plurality of spokes and a second spoke of the second plurality of spokes form a spoke assembly for the wheel assembly. At least a portion of a first spoke of the first plurality of spokes is set at an angle relative to at least a portion of a second spoke of the second plurality of spokes. The selected angle causes the first spoke to be substantially in contact with the second spoke at a first joining end of the spoke assembly proximate to the first joining location, and causes the first spoke to be separated a selected distance from the second spoke at a second joining end of the spoke assembly proximate to the second joining location, such that a space is formed between the at least a portion of the first spoke and the at least a portion of the second spoke. The reinforced plastic includes a carbon fiber reinforced plastic (CFRP), a glass fiber reinforced plastic (GFRP), or a graphene flake reinforced plastic (GHFRP).

In some embodiments, at least one of the outer disc, the inner disc, and the rim are formed by: providing a plurality of thermoset reinforced plastic patches; layering the plurality of thermoset reinforced plastic patches into at least a first layer and a second layer, wherein the orientation of the thermoset reinforced plastic patches of the second layer are at a selected angle relative to the thermoset reinforced plastic patches of the first layer; compacting the plurality of thermoset reinforced plastic patches; and curing the compacted plurality of thermoset reinforced plastic patches. At least one of a spoke of the first plurality of spokes of the outer disc or a spoke of the second plurality of spokes of the inner disc is formed during the layering of the plurality of thermoset reinforced plastic patches, or at least one of a spoke of the first plurality of spokes of the outer disc or a spoke of the second plurality of spokes of the inner disc is formed following a removal of material via at least one of a trimming process or a cutting process after the curing process.

In some embodiments, at least one of the outer disc, the inner disc, and the rim are formed by: providing layers of thermoplastic reinforced plastic; consolidating the layers of thermoplastic reinforced plastic to construct a preform; and thermoforming the preform. At least one of a spoke of the first plurality of spokes of the outer disc or a spoke of the second plurality of spokes of the inner disc is formed during the thermoforming process, or at least one of a spoke of the first plurality of spokes of the outer disc or a spoke of the second plurality of spokes of the inner disc is formed following a removal of material via at least one of a trimming process or a cutting process after the thermoforming process.

In some embodiments, the rim is formed from a metal via an extrusion process, a casting process, or a forging process. In some embodiments, the wheel assembly has an increased resistance to buckling forces or Euler bending forces via one or more of: a bow-shaped section on at least one of the first spoke of the outer disc or the second spoke of the inner disc; and a forming element between adjacent spokes of the respective first plurality of spokes and second plurality of spokes.

In some embodiments, the outer disc includes a first portion of a hub that is formed with the first plurality of spokes. The inner disc includes a second portion of the hub that is formed with the second plurality of spokes. The first portion of the hub is coupled to the second portion of the hub at the second joining location. At least one of the first portion of the hub and the first plurality of spokes or the second portion of the hub and the second plurality of spokes are formed from a blank that includes one or more relief structures to increase limit drawing ratio (LDR) resistance. In some embodiments, the method includes, but is not limited to, providing a spacer; and coupling the spacer to the hub at the second joining location, wherein the spacer is either: positioned interior to the hub; or positioned between the first portion of the hub and the second portion of the hub. In some embodiments, the method includes, but is not limited to, performing at least one surface treatment process on the formed wheel assembly, wherein the at least one surface treatment process includes a grinding process, a polishing process, or an applying of a coating.

In some embodiments, the outer disc, the inner disc, and the rim are joined via at least one of: a screw plate assembly proximate to the first joining location; an increased or enlarged flange section formed on at least one of the outer disc and the inner disc at the first joining location; adhesive bonding or mechanical fastening at a foam core located within the rim proximate to the first joining location and/or the second joining location; and adhesive bonding between overmolding formed on at least one of the outer disc, the inner disc, and the rim. In some embodiments, openings formed between adjacent spokes in at least one of the first plurality of spokes and the second plurality of spokes are operable as ventilation holes for the wheel assembly. In some embodiments, the method includes, but is not limited to, coupling a debris inhibitor to at least one of the outer disc and the inner disc proximate to openings between adjacent spokes of the respective first plurality of spokes and second plurality of spokes, wherein the debris inhibitor is operable to prevent airflow-inhibiting buildup within the openings.

In some embodiments, at least one of the outer disc and the inner disc are formed with overmolding subcomponents that assist in the coupling of the outer disc and the inner disc, wherein the overmolding features are usable as at least one of wheel enhancement features and aesthetic design features of the wheel assembly. In some embodiments, the method includes, but is not limited to, coupling a protection element to the outer disc at a position on an exterior surface of the outer disc, wherein the protection element is operable to prevent damage to at least one of the outer disc and the rim.

In some embodiments, the method includes, but is not limited to, coupling a wheel fastener recipient to at least one of the outer disc and the inner disc, wherein the wheel fastener recipient is operable to position and secure lug nuts within the wheel assembly.

In embodiments, the present disclosure is directed to a method for fabricating a wheel assembly. The method may include, but is not limited to, forming a first component for the wheel assembly from a reinforced plastic, wherein the first component includes a first plurality of spokes. The method may include, but is not limited to, forming a second component for the wheel assembly from a metal via an extrusion process, a casting process, or a forging process, wherein the second component includes a second plurality of spokes. The method may include, but is not limited to, forming the wheel assembly from the first component and the second component. The first component and the second component are coupled at a first joining location and a second joining location. A first spoke of the first plurality of spokes and a second spoke of the second plurality of spokes form a spoke assembly for the wheel assembly. At least a portion of a first spoke of the first plurality of spokes is set at an angle relative to at least a portion of a second spoke of the second plurality of spokes. The selected angle causes the first spoke to be substantially in contact with the second spoke at a first joining end of the spoke assembly proximate to the first joining location, and causes the first spoke to be separated a selected distance from the second spoke at a second joining end of the spoke assembly proximate to the second joining location, such that a space is formed between the at least a portion of the first spoke and the at least a portion of the second spoke. The reinforced plastic includes a carbon fiber reinforced plastic (CFRP), a glass fiber reinforced plastic (GFRP), or a graphene flake reinforced plastic (GHFRP).

In some embodiments, the first component includes an outer wheel disc formed from the reinforced plastic, the second component includes an integrated rim and inner wheel disc formed from the metal, and the first component is coupled exterior to the second component when forming the wheel assembly.

In some embodiments, the first component includes an inner wheel disc formed from the reinforced plastic, the second component includes an integrated rim and outer wheel disc formed from the metal, and the first component is coupled interior to and within a cavity defined by the second component when forming the wheel assembly.

In some embodiments, the first component includes an outer wheel disc with an integrated first rim portion, the second component includes an inner wheel disc within an integrated second rim portion, the first component is coupled exterior to the second component when forming the wheel assembly, and the first rim portion and the second rim portion form a rim for the wheel assembly when the first component is coupled to the second component.

In some embodiments, the first component is formed by: providing a plurality of thermoset reinforced plastic patches; layering the plurality of thermoset reinforced plastic patches into at least a first layer and a second layer, wherein the orientation of the thermoset reinforced plastic patches of the second layer are at a selected angle relative to the thermoset reinforced plastic patches of the first layer; compacting the plurality of thermoset reinforced plastic patches; and curing the compacted plurality of thermoset reinforced plastic patches. At least one spoke of the first plurality of spokes of the first component is formed during the layering of the plurality of thermoset reinforced plastic patches, or at least one spoke of the first plurality of spokes of the first component is formed following a removal of material via at least one of a trimming process or a cutting process after the curing process.

In some embodiments, the first component is formed by: providing layers of thermoplastic reinforced plastic; consolidating the layers of thermoplastic reinforced plastic to construct a preform; and thermoforming the preform. At least one spoke of the first plurality of spokes of the first component is formed during the thermoforming process, or at least one spoke of the first plurality of spokes of the first component is formed following a removal of material via at least one of a trimming process or a cutting process after the thermoforming process.

In some embodiments, the wheel assembly has an increased resistance to buckling forces or Euler bending forces via one or more of: a bow-shaped section on at least one of the first spoke of the first component or the second spoke of the second component; and a forming element between adjacent spokes of the respective first plurality of spokes and second plurality of spokes.

In some embodiments, the first component includes a first portion of a hub that is formed with the first plurality of spokes. The second component includes a second portion of the hub that is formed with the second plurality of spokes. The first portion of the hub is coupled to the second portion of the hub at the second joining location. At least one of the first portion of the hub and the first plurality of spokes or the second portion of the hub and the second plurality of spokes are formed from a blank that includes one or more relief structures to increase limit drawing ratio (LDR) resistance. In some embodiments, the method includes, but is not limited to, providing a spacer; and either: coupling the spacer to the hub at the second joining location, wherein the spacer is either: positioned interior to the hub; or positioned between the first portion of the hub and the second portion of the hub. In some embodiments, the method includes, but is not limited to, performing at least one surface treatment process on the formed wheel assembly, wherein the at least one surface treatment process includes a grinding process, a polishing process, or an applying of a coating.

In some embodiments, the first component and the second component are joined via at least one of: a screw plate assembly proximate to the first joining location; an increased or enlarged flange section on at least one of the first component and the second component at the first joining location; adhesive bonding or mechanical fastening at a foam core located within the second component proximate to the first joining location and/or the second joining location; and adhesive bonding between overmolding formed on at least one of the first component and the second component.

In some embodiments, openings formed between adjacent spokes in at least one of the first plurality of spokes and the second plurality of spokes are operable as ventilation holes for the wheel assembly. The method includes, but is not limited to, coupling a debris inhibitor to at least one of the first component or the second component proximate to openings between adjacent spokes of the respective first plurality of spokes and second plurality of spokes, wherein the debris inhibitor is operable to prevent airflow-inhibiting buildup within the openings.

In some embodiments, at least one of the first component and the second component are formed with overmolding subcomponents that assist in the coupling of the first component and the second component, wherein the overmolding features are usable as at least one of wheel enhancement features and aesthetic design features of the wheel assembly. The method includes, but is not limited to, coupling a protection element to the wheel assembly, wherein the protection element is operable to prevent damage to at least one of the first component and the second component.

In some embodiments, the method includes, but is not limited to, coupling a wheel fastener recipient to at least one of the first component and the second component, wherein the wheel fastener recipient is operable to position and secure lug nuts within the wheel assembly.

In embodiments, the present disclosure is directed to a method for fabricating a wheel assembly. The method may include, but is not limited to, forming a first component for the wheel assembly from a reinforced plastic, wherein the first component includes a first plurality of spokes. The method may include, but is not limited to, forming a second component for the wheel assembly from the reinforced plastic, wherein the second component includes a second plurality of spokes. The method may include, but is not limited to, forming the wheel assembly from the first component and the second component, wherein the first component and the second component are coupled at a first joining location and a second joining location. A first spoke of the first plurality of spokes and a second spoke of the second plurality of spokes form a spoke assembly for the wheel assembly. At least a portion of a first spoke of the first plurality of spokes is set at an angle relative to at least a portion of a second spoke of the second plurality of spokes. The selected angle causes the first spoke to be substantially in contact with the second spoke at a first joining end of the spoke assembly proximate to the first joining location, and causes the first spoke to be separated a selected distance from the second spoke at a second joining end of the spoke assembly proximate to the second joining location, such that a space is formed between the at least a portion of the first spoke and the at least a portion of the second spoke. The reinforced plastic includes a carbon fiber reinforced plastic (CFRP), a glass fiber reinforced plastic (GFRP), or a graphene flake reinforced plastic (GHFRP).

In some embodiments, the first component includes an outer wheel disc formed from the reinforced plastic, the second component includes an integrated rim and inner wheel disc formed from the reinforced plastic, and the first component is coupled exterior to the second component when forming the wheel assembly.

In some embodiments, the first component includes an inner wheel disc formed from the reinforced plastic, the second component includes an integrated rim and outer wheel disc formed from the reinforced plastic, and the first component is coupled interior to and within a cavity defined by the second component when forming the wheel assembly.

In some embodiments, the first component includes an outer wheel disc with an integrated first rim portion, the second component includes an inner wheel disc within an integrated second rim portion, the first component is coupled exterior to the second component when forming the wheel assembly, and the first rim portion and the second rim portion form a rim for the wheel assembly when the first component is coupled to the second component.

In some embodiments, at least one of the first component and the second component is formed by: providing a plurality of thermoset reinforced plastic patches; layering the plurality of thermoset reinforced plastic patches into at least a first layer and a second layer, wherein the orientation of the thermoset reinforced plastic patches of the second layer are at a selected angle relative to the thermoset reinforced plastic patches of the first layer; compacting the plurality of thermoset reinforced plastic patches; and curing the compacted plurality of thermoset reinforced plastic patches. At least one spoke of the first plurality of spokes or the second plurality of spokes is formed during the layering of the plurality of thermoset reinforced plastic patches, or at least one spoke of the first plurality of spokes or the second plurality of spokes is formed following a removal of material via at least one of a trimming process or a cutting process after the curing process.

In some embodiments, at least one of the first component and the second component is formed by: providing layers of thermoplastic reinforced plastic; consolidating the layers of thermoplastic reinforced plastic to construct a preform; and thermoforming the preform. At least one spoke of the first plurality of spokes or the second plurality of spokes is formed during the thermoforming process, or at least one spoke of the first plurality of spokes or the second plurality of spokes is formed following a removal of material via at least one of a trimming process or a cutting process after the thermoforming process.

In some embodiments, the wheel assembly has an increased resistance to buckling forces or Euler bending forces via one or more of: a bow-shaped section on at least one of the first spoke of the first component or the second spoke of the second component; and a forming element between adjacent spokes of the respective first plurality of spokes and second plurality of spokes.

In some embodiments, the first component includes a first portion of a hub that is formed with the first plurality of spokes. The second component includes a second portion of the hub that is formed with the second plurality of spokes. The first portion of the hub is coupled to the second portion of the hub at the second joining location. At least one of the first portion of the hub and the first plurality of spokes or the second portion of the hub and the second plurality of spokes are formed from a blank that includes one or more relief structures to increase limit drawing ratio (LDR) resistance. In some embodiments, the method includes, but is not limited to, providing a spacer; and either: coupling the spacer to the hub at the second joining location, wherein the spacer is either: positioned interior to the hub; or positioned between the first portion of the hub and the second portion of the hub. In some embodiments, the method includes, but is not limited to, performing at least one surface treatment process on the formed wheel assembly, wherein the at least one surface treatment process includes a grinding process, a polishing process, or an applying of a coating.

In some embodiments, the first component and the second component are joined via at least one of: a screw plate assembly proximate to the first joining location; an increased or enlarged flange section on at least one of the first component and the second component at the first joining location; adhesive bonding or mechanical fastening at a foam core located within the second component proximate to the first joining location and/or the second joining location; and adhesive bonding between overmolding formed on at least one of the first component and the second component.

In some embodiments, openings formed between adjacent spokes in at least one of the first plurality of spokes and the second plurality of spokes are operable as ventilation holes for the wheel assembly. The method includes, but is not limited to, coupling a debris inhibitor to at least one of the first component or the second component proximate to openings between adjacent spokes of the respective first plurality of spokes and second plurality of spokes, wherein the debris inhibitor is operable to prevent airflow-inhibiting buildup within the openings.

In some embodiments, at least one of the first component and the second component are formed with overmolding subcomponents that assist in the coupling of the first component and the second component, wherein the overmolding features are usable as at least one of wheel enhancement features and aesthetic design features of the wheel assembly. The method includes, but is not limited to, coupling a protection element to the wheel assembly, wherein the protection element is operable to prevent damage to at least one of the first component and the second component.

In some embodiments, the method includes, but is not limited to, coupling a wheel fastener recipient to at least one of the first component and the second component, wherein the wheel fastener recipient is operable to position and secure lug nuts within the wheel assembly.

In embodiments, the present disclosure is directed to a method to prevent Euler buckling in a wheel assembly, wherein the wheel assembly includes a first component that is a vehicle-side spoke and the second component that is a curb-side spoke, wherein the first component is shaped with a bow-shape to prevent Euler buckling, wherein the first component contains radial forming elements to prevent Euler buckling, wherein the first component is supported by the second component, wherein at least of the first component and the second component includes at least one formed segment to enable a supporting contact of the first component and the second component, wherein the first and the second component are connected by a third linking component keeping the first component in position, and wherein the cavity between first and the second component is filled with a structural foam.

In embodiments, the present disclosure is directed to a method to join a wheel assembly, wherein the wheel assembly includes a first component that is a vehicle-side spoke, a second component that is a curb-side spoke, a third component that is a rim, and a fourth component which is a subassembly of the vehicle-side spoke and of at least a portion of the rim or the curb-side spoke and the at least a portion of the rim, wherein at least 2 screw-nut combination are integrated on a plate forming a screw plate, wherein the screw plate joins the at least two components of the for components, wherein the plate is a design and protection element for the first component, and wherein the plate exhibits a surface layer or coating to be used as an aesthetic element for the first component.

In embodiments, the present disclosure is directed to a method to join a wheel assembly, including joining a curb-side wheel-member as a first component and a vehicle-side wheel member as the second component, wherein an overmolding provides a surface area which is used for adhesive bonding the 2 components, wherein an overmolding provides a cavity to accommodate an adhesive foam bonding the 2 components, wherein the closed cavity between the components is injected with an adhesive foam bonding the 2 components, and wherein a third component which is positioned between the first and the second component is bonding the first and second component.

In embodiments, the present disclosure is directed to a method to protect a wheel spoke-assembly from trapping dirt, wherein the wheel-spoke assembly includes a first component that is a vehicle-side spoke, and a second component that is a curb-side spoke, wherein the first and second component forming an acute angle close the wheel rim, wherein a wedge shaped element is incorporated among first and second component to fill the acute angle near the rim, wherein a material is injected between first and second component to fill the acute angle near the rim, wherein the injection of the material is part of an overmolding process, and wherein the shape of the spoke can be made by casting or forging processes.

In one non-limiting example, the wheel assembly comprises outer and inner spokes mounted to a circular rim, wherein the inner and outer spoke intersect at the rim and diverge from each other at an angle towards a center of the circular rim, and wherein a debris inhibitor is positioned between the inner and outer spoke surfaces near the rim to direct debris away from the intersection of the inner and outer spoke members. For instance, the inhibitor is in a wedge shape, and a plane of the wedge shape is substantially parallel to a plane or rotation of the rim. In addition, the inhibitor is in a wedge shape, and a plane of the wedge shape is substantially normal to an axis of rotation of the rim.

In embodiments, the present disclosure is directed to a method to maximize the stiffness of a wheel center, wherein the wheel center includes of a number of casted or forged aluminum spokes, wherein each spoke has a curb-side surface (CS) and a vehicle-side surface (VS), wherein the other two spoke-surfaces A1 and A2 are perpendicular to curb-side surface and a vehicle-side surface, wherein the surfaces CS and VS forming a triangle with the acute angle of the triangle at the rim, and wherein the surfaces A1 and A2 forming an I-beam geometry with a connecting member in the rotational plane of the wheel.

In embodiments, the present disclosure is directed to a method to increase a stiffness of the wheel rim structure, wherein the wheel rim structure includes a rim center, a curb-side rim flange, and a vehicle-side rim flange. In some embodiments, the rim center includes a recurring pattern, a cavity, and/or a foam inserted within the recurring pattern or the cavity.

In one non-limiting example, the wheel assembly includes a hub, and a circular rim surrounding the hub, wherein a surface the rim comprises plural indentations separated by plural ridges in a recurring pattern around a periphery of the rim, and wherein the indentations are a polygon or a circle or a combination thereof. For instance, the indentations are polygonal in shape. In addition, the indentations are circular in shape.

In embodiments, the present disclosure is directed to a method to increase a stiffness of the wheel rim structure, wherein the wheel rim structure includes a rim center, a curb-side rim flange, and a vehicle-side rim flange. In some embodiments, the vehicle-side rim flange exhibits a forming element creating at least one cavity. In some embodiments the at least one cavity contains air, a gas, or a lightweight material or foam.

In embodiments, the present disclosure is directed to a method of manufacturing a wheel rim, including positioning metal foam precursor pellets in a void space between inner and outer surfaces of a rim; thereafter heating the metal foam precursor pellets to form a metal foam in the void space; and sealing the metal form in the void space to form the wheel rim. For example, the metal foam comprises aluminum. By way of another example, the metal foam is a composite foam.

In embodiments, the present disclosure is directed to a method of manufacturing a wheel hub member, including positioning metal foam precursor pellets in a void space between inner and outer surfaces of a wheel hub member; thereafter heating the metal foam precursor pellets to form a metal foam in the void space; and sealing the metal form in the void space to form the wheel hub member. For example, the metal foam comprises aluminum and the wheel hub member is a spoke. By way of another example, the metal foam is a composite foam and the wheel hub member is a center hub.

In embodiments, the present disclosure is directed to a wheel assembly, including a circular rim; a hub member positioned at an axis of rotation of the circular rim; and a plurality of spokes radiating outwardly from an exterior surface of the hub member to an interior surface of the rim, wherein: each of the plurality of spokes is removably connected to the hub member and the rim; and each of the plurality of spokes comprises a space located interiorly of upper and lower surfaces of the respective spoke and a support member extending transversely between the upper and lower surfaces, the interior space having a triangular cross section along a length of the respective spoke.

In embodiments, the present disclosure is directed to a wheel assembly formed by any of the methods as described herein and/or as illustrated in the figures and described in the corresponding descriptions herein, with any combination of embodiments or aspects of the wheel assemblies as described herein.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and claims are to be understood as being modified in all instances by the term “about” or “approximately” or “substantially.” One skilled in the art will appreciate that these terms, for instance, can imply variation, on a relative basis, of less than 10%.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and Claims themselves.

The Summary is neither intended, nor should it be construed, as being representative of the full extent and scope of the present disclosure. Moreover, references made herein to “the present disclosure” or aspects thereof should be understood to mean certain embodiments of the present disclosure and should not necessarily be construed as limiting all embodiments to a particular description. The present disclosure is set forth in various levels of detail in the Summary as well as in the attached Drawings and the Detailed Description and no limitation as to the scope of the present disclosure is intended by either the inclusion or non-inclusion of elements or components. Additional aspects of the present disclosure will become more readily apparent from the Detailed Description, particularly when taken together with the Drawings.

Any one or more aspects described herein can be combined with any other one or more aspects described herein. Any one or more features described herein can be combined with any other one or more features described herein. Any one or more embodiments described herein can be combined with any other one or more embodiments described herein.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various embodiments of the disclosure, as illustrated by the drawings referenced below.

FIG. 1 is a cut-away perspective view showing a wheel according to prior art;

FIG. 2 is an exploded perspective view showing a circular rim and two non-planar 2-dimensional components according to embodiments of the present disclosure;

FIG. 3A is an exploded cut-away perspective view showing a circular rim and two non-planar 2-dimensional components according to embodiments of the present disclosure;

FIG. 3B is a cut-away perspective view showing the wheel assembly of FIG. 3A;

FIG. 3C is a front view showing the wheel assembly of FIG. 3A;

FIG. 4A is a front view showing an aero wheel assembly according to embodiments of the present disclosure;

FIG. 4B is a perspective view showing the aero wheel assembly of FIG. 4A;

FIG. 5A is a front perspective view of a fastening plate according to embodiments of the present disclosure;

FIG. 5B is a rear perspective view of the fastening plate of FIG. 5A;

FIG. 5C is a cut-away perspective view of the fastening plate of FIG. 5A securing a hub member to an intermediate wheel assembly;

FIG. 6 is an exploded perspective view of a wheel assembly, according to embodiments of the present disclosure;

FIG. 7A is a cross sectional view of a rim according to prior art;

FIG. 7B is a cross sectional view of a rim according to embodiments of the present disclosure;

FIG. 8 is a cross section view of a CFRP sheet according to embodiments of the present disclosure;

FIG. 9A is an interior cross-sectional view of a rim according to embodiments of the present disclosure;

FIG. 9B is an exterior perspective cross-sectional view of the rim of FIG. 9A;

FIG. 10A is a partial perspective view of a rim with recuring pattern according to embodiments of the present disclosure;

FIG. 10B is a partial side view of a rim with recuring pattern according to embodiments of the present disclosure;

FIG. 11A is a plot of tension versus compression at 300 MPa;

FIG. 11B is a plot of tension versus compression at 150 MPa;

FIG. 12 is a cross section view of a rim according to embodiments of the present disclosure;

FIG. 13 is a cross section view of a rim according to embodiments of the present disclosure;

FIG. 14 is a cross section schematic view of a metallic foam-filled rim section according to embodiments of the present disclosure;

FIG. 15 is a cross section view of a rim according to embodiments of the present disclosure;

FIG. 16 is a cross section view of a rim according to prior art;

FIG. 17A is a perspective cross-sectional view of a wheel assembly according to embodiments of the present disclosure;

FIG. 17B is a side cross-sectional view of a wheel assembly of FIG. 17A embodiments of the present disclosure;

FIG. 18A shows stress distribution over the rim of FIGS. 17A and 17B;

FIG. 18B shows stress distribution over a rim according to prior art;

FIG. 19A is a side cross-sectional view depicting an intermediate wheel assembly with metallic foam precursor pellets in position between opposing plates according to embodiments of the present disclosure;

FIG. 19B is a perspective cross-sectional view depicting an intermediate wheel assembly after formation of the metallic foam according to embodiments of the present disclosure;

FIG. 20A is a perspective view of a wheel assembly showing a hub member positioned adjacent to an intermediate wheel assembly according to embodiments of the present disclosure;

FIG. 20B is a perspective view of the wheel assembly of FIG. 20A after installation of the hub member;

FIG. 21A is a partial cross-sectional view of a wheel assembly according to embodiments of the present disclosure;

FIG. 21B is a perspective view of the wheel assembly of FIG. 21A;

FIG. 22A is a perspective view of a wheel assembly according to embodiments of the present disclosure;

FIG. 22B is a partial perspective cross-section view of the wheel assembly of FIG. 22A;

FIG. 22C is another partial perspective cross-section view of the wheel assembly of FIG. 22A;

FIG. 23A is a perspective view of a wheel assembly showing a hub member positioned adjacent to an intermediate wheel assembly according to embodiments of the present disclosure;

FIG. 23B is a perspective view of an inhibitor according to embodiments of the present disclosure;

FIG. 24A is a front view of a wheel assembly according to embodiments of the present disclosure;

FIG. 24B is a front view of a wheel assembly according to embodiments of the present disclosure;

FIG. 24C is a perspective view of the wheel assembly of FIG. 24A;

FIG. 25A is a partial perspective cross-section view of the wheel assembly of FIG. 24A;

FIG. 25B is an exploded perspective view of a wheel assembly showing a hub member positioned adjacent to an intermediate wheel assembly during manufacture of the wheel assembly of FIG. 24A;

FIG. 26A is a perspective view of a hub without cut outs according to embodiments of the present disclosure;

FIG. 26B is a perspective view of a hub with cut outs according to embodiments of the present disclosure;

FIG. 26C is a side cross-sectional view of the hub of FIG. 26A showing the cylinder at the center of the hub;

FIG. 26D is a side cross-sectional view of the hub of FIG. 26B showing the cylinder at the center of the hub;

FIG. 26E is a perspective view of a wheel assembly with the hub of FIG. 26B;

FIG. 27A is a side cross-sectional view of a wheel assembly according to embodiments of the present disclosure;

FIG. 27B is a side cross-sectional view of another wheel assembly according to embodiments of the present disclosure;

FIG. 28 is an exploded perspective view of a wheel-cap adjacent to a wheel according to embodiments of the present disclosure;

FIG. 29A is an exploded cut-away perspective view of a curb-side wheel member adjacent to an intermediate assembly according to embodiments of the present disclosure;

FIG. 29B is an exploded cut-away perspective view of a brake-side wheel member adjacent to an intermediate assembly according to embodiments of the present disclosure;

FIG. 30 is a cross-section view of a rim assembly according to embodiments of the present disclosure;

FIG. 31A is a cross-sectional view of a center-rim assembly according to embodiments of the present disclosure;

FIG. 31B is a cut-away perspective view of the center-rim assembly of FIG. 31A;

FIG. 32A is an elevation view of a standard flange according to prior art;

FIG. 32B is an elevation view of a flange with interface modulation according to embodiments of the present disclosure;

FIG. 33A shows a wheel hub sandwich structure according to embodiments of the present disclosure;

FIG. 33B shows a variation of the wheel hub sandwich structure of FIG. 32A;

FIG. 34 is a principal sketch of the triangular center geometry according to embodiments of the present disclosure;

FIG. 35A is a cut-away perspective of an indentation on a vehicle-side spoke of a wheel assembly, according to embodiments of the present disclosure;

FIG. 35B is an exploded cut-away perspective view of the wheel assembly of FIG. 35A;

FIG. 36A is a cut-away perspective view of indentations on a vehicle-side disc-member of a wheel assembly, according to embodiments of the present disclosure;

FIG. 36B is an exploded cut-away perspective view of the wheel assembly of FIG. 36B; and

FIG. 37 is a cut-away perspective view of a frontbone structure with integrated electrical motor casing, according to embodiments of the present disclosure.

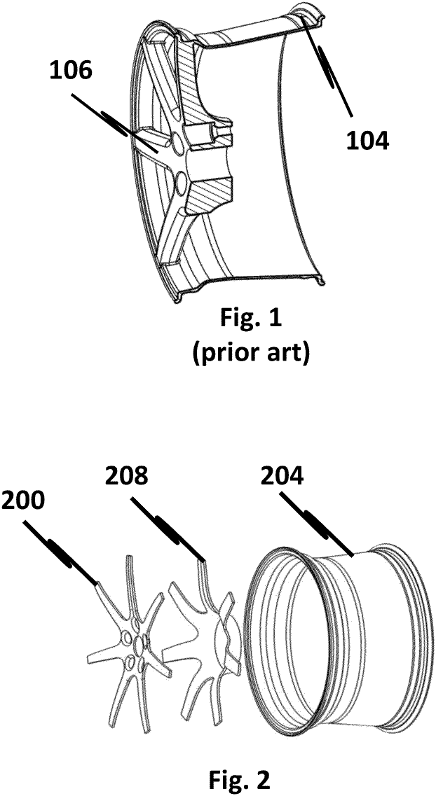

### DETAILED DESCRIPTION

### Hybrid Wheel Structures and Special Functionalities

It is noted that PCT Application No. PCT/US2020/016236, U.S. Pat. Application No. 17/427,575, PCT Application No. PCT/US2022/024190, and U.S. Pat. Application No. 17/695,595 describes select principles and manufacturing methods of wheel structures, which are each incorporated herein by reference in the entirety.

The wheel structure of the present disclosure enables advanced reinforced plastic (RP) or Metal-RP hybrid solutions. The disclosure describes new, novel, and non-obvious combinations of various semi-finished products as forgings, castings, RP, or sheet metals forming hybrid multi-material solutions. The multi-material solutions require specific joining and manufacturing sequences which are described in this innovation. For purposes of the present disclosure, reinforced plastics (RP) may include, but are not limited to, carbon-fiber reinforced plastics (CFRP), glass fiber reinforced plastics (GFRP), graphene flakes reinforced plastics (GHFRP), or the like.

As will be appreciated, carbon-fiber reinforced polymers are composite materials relying on carbon fiber to provide strength and stiffness while the polymer provides a cohesive matrix to protect and hold the fibers together and provide toughness. Carbon fibers can provide highly directional properties much different than the metals most commonly used for automotive applications. The binding polymer is often a thermoset resin such as epoxy, but other thermoset or thermoplastic polymers, such as polyester, vinyl ester, or nylon, are sometimes used. The properties of the final CFRP product can be affected by the type of additives introduced to the binding matrix (resin). The most common additive is silica, but other additives such as rubber, carbon nanotubes, and ceramic nanoparticles can be used.

The primary element of CFRP is a carbon filament; which is produced from a precursor polymer such as polyacrylonitrile (PAN), rayon, or petroleum pitch. For synthetic polymers such as PAN or rayon, the precursor is first spun into filament yarns, using chemical and mechanical processes to initially align the polymer chains in a way to enhance the final physical properties of the completed carbon fiber. Precursor compositions and mechanical processes used during spinning filament yarns may vary among manufacturers. After drawing or spinning, the polymer filament yarns are then heated to drive off non-carbon atoms (carbonization), producing the final carbon fiber. The carbon fibers filament yarns may be further treated to improve handling qualities. From these fibers, a unidirectional sheet is created. These sheets are layered onto each other in a quasi-isotropic layup, e.g. 0°, +60°, or -60° relative to each other (or other angles for layers, not being limited to any particular angle relationship for purposes of the present disclosure).

From the elementary fiber, a bidirectional woven sheet can be created, i.e., a twill with a 2/2 weave. The process by which most CFRPs are made varies, depending on the piece being created, the finish (outside gloss) required, and how many of the piece will be produced. In addition, the choice of matrix can have a profound effect on the properties of the finished composite. Many CFRP parts are created with a single layer of carbon fabric that is backed with fiberglass.

One method of producing CFRP parts is by layering sheets of carbon fiber cloth into a mold in the shape of the final product. The alignment and weave of the cloth fibers is chosen to optimize the strength and stiffness properties of the resulting material. The mold is then filled with epoxy and is heated or air-cured. The resulting part can be very corrosion-resistant, stiff, and strong for its weight.

A typical structure of CFRP is shown in FIG. 8, in which plural independent or discrete carbon fibers 808 are embedded in a polymeric or resin matrix 804 to form a CFRP sheet 800. In some embodiments, a carbon fiber reinforced composite comprises a matrix, fiber or fibers, and an interphase region. For example, the CFRP sheet 800 has a fiber volume fraction ranging from about 45% to about 85%. For instance, the volume fraction may range from about 55% to about 75%. The CFRP sheet can contain one or more other additives in a range of from about 0.5 to about 35 vol.%. The matrix can endow the composite with key properties. The coefficient of thermal expansion of carbon fibers is typically much lower than that of most matrices, so carbon fibers significantly increase the composite stability. In a CFRP composite, the thickness of a single layer is typically about 0.05-0.2 mm and a lamina with fibers in only one direction is called a unidirectional lamina. In order to obtain engineering components, some layers are stacked to form a laminate composed of several plies with different orientations according to the required thickness.

Special features are described herein to improve usability and effectiveness of the wheel structures described herein, including specific aesthetic and engineering design examples.
1. Fiber reinforced plastics for wheel structures
   a. Glass fiber reinforced plastic (GFRP)
   b. Carbon fiber reinforced plastic (CFRP)
   c. Graphene flakes reinforced plastic (GHFRP)
2. Specific wheel manufacturing methods for composites
   a. Layered fiber composites including CFRP cloths with reduced number of pieces or patches
   b. Prefabricated flat or curved composites including flat or curved composites
   c. Production sequence and tooling
   d. Carbon fiber component or sheet on supporting metal structure
   e. Joining techniques to connect the hybrid wheel components
3. Special features of the described wheel structures
   a. Stiffened by local sub-structure on the inner wheel (either with or without cavity)
   b. Stiffened by periodically recurring pattern in the rim
   c. Wheel structures filled with technical foam / injection moldings
   d. Enforced ventilation by fan geometry
   e. Wheel protection to prevent damage from curb
   f. Castable wheel with CFRP elements
   g. Dirt protection, avoiding trapped dirt
   h. Vehicle-side spokes with enhanced impact resistance
   i. Connecting curb-side and vehicle-side structures to enhance impact resistance
   j. Increase of effective limit drawing ratio for the manufacture of wheel assemblies of the present disclosure
   k. Improved clearance for brake caliper
   l. Overmolding locking features
   m. Overmolding aesthetic design options
   n. Wheel bolt lug nut / wheel interface
   o. Backbone and Frontbone design
   p. Surface treatment
   q. Wheel spacer
   r. Conditions of the center geometry

### 1. Fiber Reinforced Plastics for Wheel Structures

This section describes solutions based on composites, preferably CFRP and Aluminum-CFRP hybrid solutions. Various material combinations are possible to combine the inner disc component, the outer disc component and the rim. Various CFRP manufacturing concepts are described for reinforced plastics including, but not limited to, (a) carbon-fiber reinforced plastics (CFRP), (b) glass fiber reinforced plastics (GFRP), (c) graphene flakes reinforced plastics (GHFRP), or the like. As such, it should be appreciated that embodiments directed to CFRP as described throughout the present disclosure are provided only for purposes of illustration and should not be interpreted as limiting, and that the embodiments may similarly utilize or include any reinforced plastic (RP) as described throughout the present disclosure (e.g., GFRP, GHFRP, or the like).

### 2. Specific Wheel Manufacturing Methods for Composites

### 2A. Layered Fiber Composites Including CFRP Cloths With a Reduced Number of Pieces or Patches

The predominantly uniform shape of the wheel center enables a significantly reduced number of CFRP patches (or pieces) needed for constructing the component. Furthermore, the minimally formed components that make up the wheel center enable better accessibility for robots, allowing for a simpler and more automated CFRP manufacturing process. Reducing the number of components and increasing the level of automation in the manufacturing process leads to faster production times and ultimately lower costs.

The CFRP geometry of the wheel structures described herein is simpler to model than conventional layer-based designs, resulting in more accurate and efficient development processes. In particular, the tight radii in conventional CFRP designs can be challenging to predict with certainty. By contrast, the CFRP designs of the present disclosure a more secure design and greater product reliability.

Wheels are typically exposed to high temperatures, and as such, require temperature-stable CFRP resins that can withstand temperatures up to T=150° C. Those resins typically have higher viscosity and can be more challenging to inject into the patch layers, especially as the number of layers increases. As described herein, the use of simplified components makes it easier to ensure a smooth flow of resin compared to conventional structures with complex geometries and mass accumulations.

Table 1 provides an example comparison between wheels manufactured with a conventional design versus wheels manufactured based on the present disclosure:

TABLE 1

Conventional wheel design versus Present disclosure wheel design

| | |
|---|---|
| Conventional wheel design | Present disclosure wheel design |
| 300-700 Pieces & 40-60 Locations | 40-50 Pieces & 4-8 Locations |
| Difficult to automate | Easily automated |
| 10-hour cycle times, even at 100% automation | 1-hour cycle times |
| 3-5 year development cycle | <1 year development cycle |
| High complexity for Finite Element Modeling (FEM) | Simplified composite simulation in FEM |
| Multiple iterations in development | Rapid prototype iteration |
| Customized production means | Utilization of same production across family of wheels |

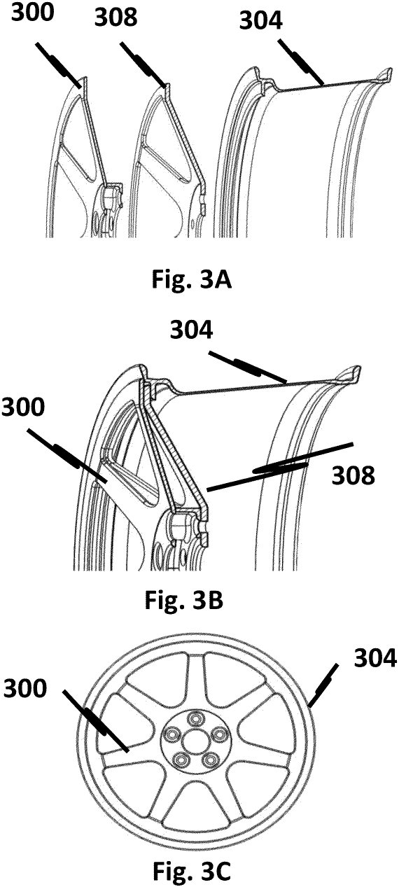

FIG. 3A shows an explosive perspective view of the rim and the two wheel discs, as assembled in a perspective view in FIG. 3B and a front view in FIG. 3C. In FIGS. 3A-3C, a wheel assembly includes a prefabricated CFRP curb-side disc-member component 300 and vehicle side CFRP disc-member 308, which are mounted on a rim 304. In one non-limiting example, the rim 304 is preferably made in CFRP.

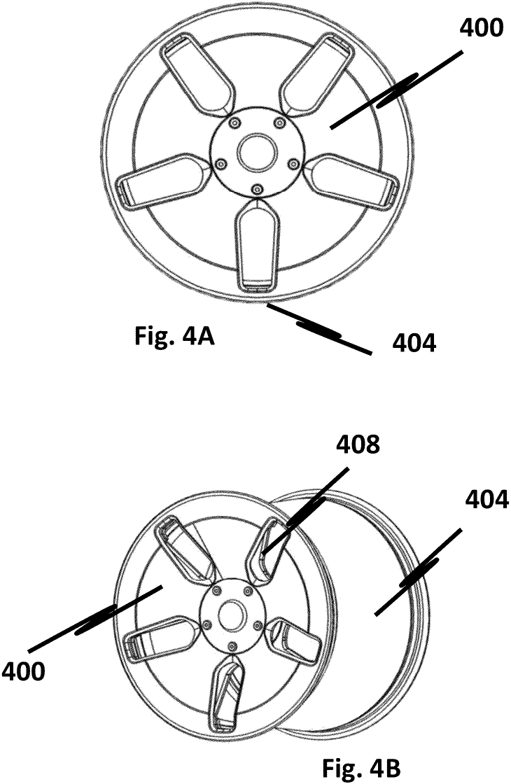

FIGS. 4A and 4B illustrate wheel discs with smaller ventilation holes for reduced drag resistance. In FIGS. 4A and 4B, a wheel assembly includes a prefabricated CFRP sheet with cut-outs 400 as the outer surface of the wheel spokes and hub mounted to the vehicle-side disc 408 and rim 404.

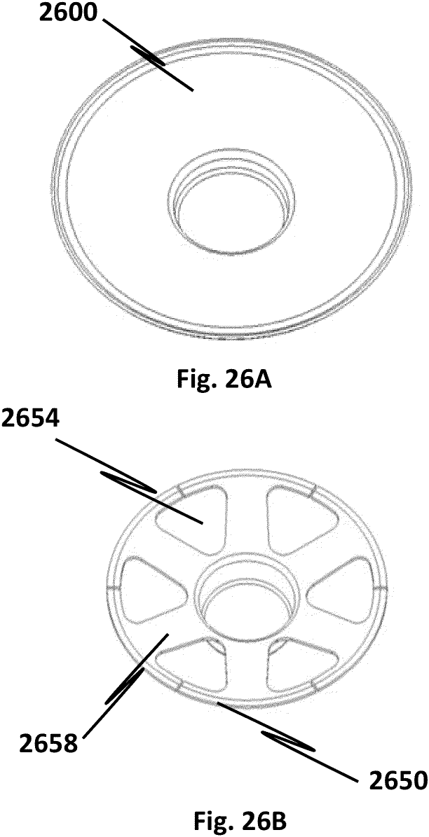

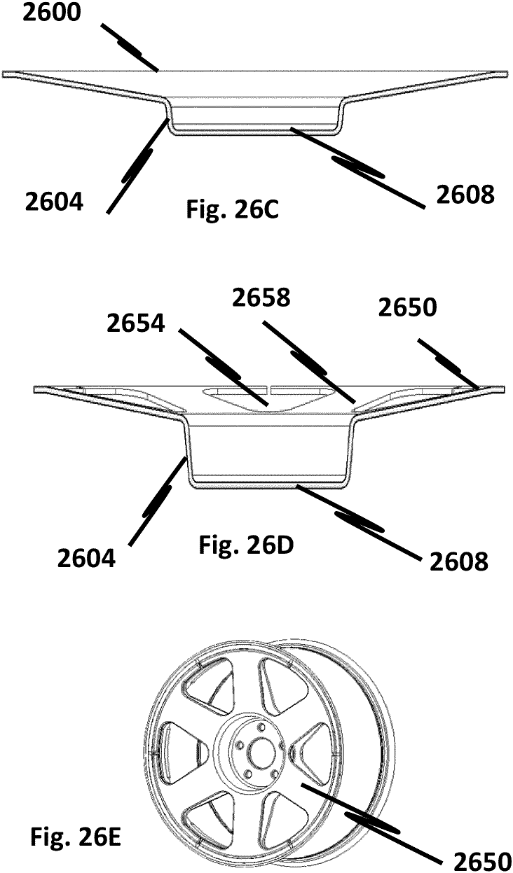

The simple geometry of the wheel center and the modularity of its components are illustrated in FIGS. 26A to 26E. The depicted prototype comprises a layered CFRP disc center. The prototype has an unfinished surface. This allows to build families of wheels utilizing the same or only slightly modified production tools.

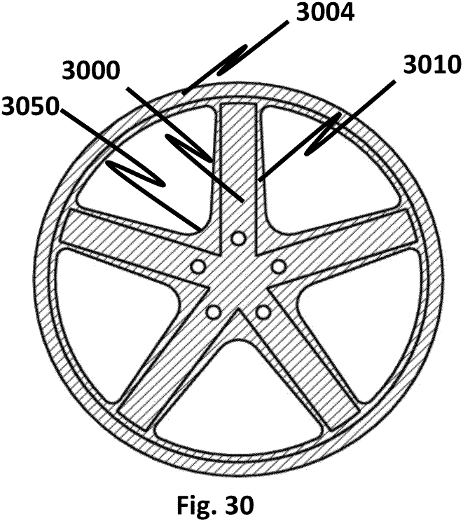

It is noted that carbon fiber designs are sensitive to stress distribution, which means that tight edges and complex shapes should be avoided. In general, the two component wheel center of the present disclosure has an advantage in this regard. However, for aesthetic reasons, designers may prefer sharp cut-outs. As such, in some embodiments the invention includes a fiber layout as illustrated in FIG. 30 that is anisotropic and non-homogeneous in fiber resin ratio. By orienting fibers primarily in the principal axis of the spoke 3010 but limited to a higher local tensile and compressive modulus can be achieved compared to the spoke area 3000 in FIG. 30. Stress concentrations are moved from the radius 3050 between in the connecting area between adjacent spokes 3010 to a location internal of each respective spoke 3010. This allows for more aesthetic design freedom of the wheel center as the radii do not have to be designed according to stress distributions. The two CFRP disc-members form the bi-planar wheel center that is mounted into the wheel rim 3004.

### 2B. Prefabricated Semi-Finished Materials Including Flat or Curved Composites

Prefabricated CFRP sheets are pre-made sheets of carbon fiber reinforced plastic (CFRP) that are manufactured in a factory and used as building blocks for various products. This on an industrial scale, cost efficient produced CFRP sheets are commercially available and can reduce fabrication time and cost of CFRP wheels.

In some embodiments, components of the wheel structures described herein utilize prefabricated flat or curved semi-finished CFRP material. In some examples, prefabricated sheets can be used that already contain cut-outs for specific wheel designs and functionalities. These cut-outs can be made using cost-efficient technologies such as milling or laser cutting. Like the previously-described layered CFRP wheel assemblies, the use of prefabricated CFRP can result in a safer design and more reliable product performance, while providing similar overall benefits.

### 2C. Production Sequence and Tooling

In this disclosure, the production of the CFRP wheel or CFRP-metal hybrid is subdivided into various stages and carried out in separate locations to ensure good accessibility and a high degree of automation in each production stage.

The production sequence for manufacturing a CFRP wheel according to the design principles described in of the present invention can vary depending on the desired build rates and specific design features. The design principles described in the present invention of the inner and outer disc-members allow for the separation of specific production steps, a production sequence similar to the described method cannot be outlined for conventional CFRP wheels. Comparted to the processes described in the present invention, the automation of conventional wheels is limited.

In some embodiments, lay-up can be accomplished through manual hand lay-up or automated composite manufacturing techniques such as automated fiber placement (AFP) and fiber patch placement (FPP). It is noted that despite targeting high automation, even a manual hand lay-up process in separate production steps is faster and safer compared to conventional CFRP wheel fabrication.

The individual carbon fiber pieces used in the CFRP wheel can be sourced from various composite weaves, unidirectional sheets, or pieces made using tailored fiber placement (TFP) techniques. Alternatively, wheel components can be constructed from long or short carbon fiber CF-SMC.

The following are examples for the division of processes used to fabricate the wheel structures of the present disclosure. The examples are provided for illustration only, and are not intended to be limiting with respect to the number of steps and/or order of performing the steps provided. In particular, one or more steps may be performed in the listed order or a different order, in a simultaneous manner or in a sequential manner, and at one or more same locations or one or more different locations.

### Examples for Thermoset Wheel Manufacture

A) 3-component division of processes:
Location or step 1: Layering the CFRP patches for the inner wheel disc, and eventually compacting
Location or step 2: Layering the CFRP patches for the outer wheel disc, and eventually compacting
Location or step 2a: Curing of sub-components including the rim, inner wheel disc, and/or outer wheel disc
Location or step 2b: Trimming and cutting of the inner wheel and/or outer wheel disc components
Location or step 3: Layering the rim and integrating both wheel discs (inner and outer) to form the wheel structure
Location or step 4: Curing the layered wheel structure
Location or step 5: Trimming and cutting the wheel structure
Location or step 6: Surface finishing on the wheel structure

B) For the division of processes in different locations are (2-component):
Location or step 1: Layering the CFRP patches for an integrated first wheel disc and rim, and eventually compacting
Location or step 1a: Curing of sub-components including the integrated first wheel disc and rim
Location or step 1b: Trimming and cutting of the rim-disc component
Location or step 2: Layering the CFRP-patches for a second wheel disc, and eventually compacting
Location or step 3: Curing the layered CFRP second wheel disc
Location or step 4: Trimming and cutting the second wheel disc
Location or step 5: Assembly of integrated rim-first wheel disc component with the second wheel disc to form the wheel structure
Location or step 6: Surface finishing of the wheel structure

It is noted the trimming and/or cutting processes may create the spokes of the wheel assembly, where the spokes are not previously formed during the layering and curing processes.

It is noted that the first wheel disc may be an inner wheel disc and the second wheel disc may be an outer wheel disc, such that the integrated first wheel disc and rim is a backbone build as described throughout the disclosure. In the alternative, it is noted that the first wheel disc may be an outer wheel disc and the second wheel disc may be an inner wheel disc, such that the integrated first wheel disc and rim is a frontbone build as described throughout the disclosure.

It is noted that the integrated first wheel disc and rim may include the entirety of the rim structure or only a portion of the rim. Where the integrated first wheel disc and rim includes only a portion of the rim, another portion of the rim may be formed with the second wheel disc. As such, the above example should only be considered illustrative, and should not be interpreted as limiting on the present disclosure.

### Examples for Thermoplastic Wheel Manufacture

A) 3-component division of processes:
Location or step 1: Layering the thermoplastic CFRP patches or tapes for the inner wheel disc, and eventually consolidating to create or construct an inner wheel disc preform
Location or step 2: Layering the thermoplastic CFRP patches or tapes for the outer wheel disc, and eventually consolidating to create or construct an outer wheel disc preform
Location or step 3: Layering the thermoplastic CFRP patches or tapes for the rim portion of the wheel, and eventually consolidating to create or construct a rim preform
Location or step 4: Thermoforming of sub-components including the rim, inner wheel disc, and/or outer wheel disc preforms
Location or step 5: Trimming and cutting of the inner wheel and/or outer wheel disc components
Location or step 6: Assembly of sub-components (inner wheels disc, outer wheel disc, rim portion, and the like) by thermoplastic welding and/or adhesively bonding and/or mechanical fastening.
Location or step 7: Surface finishing on the wheel structure

B) For the division of processes in different locations are (2-component):
Location or step 1: Layering the thermoplastic CFRP patches or tapes for an integrated first wheel disc and rim, and eventually consolidating to create or construct an integrated first wheel disc preform
Location or step 1a: Thermoforming of sub-components including the integrated first wheel disc and rim
Location or step 1b: Trimming and cutting of the rim-disc component
Location or step 2: Layering the thermoplastic CFRP patches or tapes for the second wheel disc, and eventually consolidating to create or construct a second wheel disc preform
Location or step 3: Thermoforming the layered CFRP second wheel disc
Location or step 4: Trimming and cutting the second wheel disc
Location or step 5: Assembly of the integrated rim-first wheel disc component with the second wheel disc to form the wheel structure by thermoplastic welding and/or adhesively bonding and/or mechanical fastening.
Location or step 6: Surface finishing of the wheel structure

It is noted the trimming and/or cutting processes may create the spokes of the wheel assembly, where the spokes are not previously formed during the layering and thermoforming processes.

It is noted that the first wheel disc may be an inner wheel disc and the second wheel disc may be an outer wheel disc, such that the integrated first wheel disc and rim is a backbone build as described throughout the disclosure. In the alternative, it is noted that the first wheel disc may be an outer wheel disc and the second wheel disc may be an inner wheel disc, such that the integrated first wheel disc and rim is a frontbone build as described throughout the disclosure.

It is noted that the integrated first wheel disc and rim may include the entirety of the rim structure or only a portion of the rim. Where the integrated first wheel disc and rim includes only a portion of the rim, another portion of the rim may be formed with the second wheel disc. As such, the above example should only be considered illustrative, and should not be interpreted as limiting on the present disclosure.

Although the above steps are described as being performed at separate locations, it is noted that one or more of the above steps may be performed at the same location, without departing from the scope of the present disclosure.

It is noted the two-, three-, or more components of the wheel assemblies as provided above and as described throughout the present disclosure may be coupled together (e.g., joined, affixed, or the like) via one or more of a screw plate assembly, fasteners, adhesive, welding techniques, or the like. In addition, it is noted the two-, three-, or more components of the wheel assemblies as provided above and as described throughout the present disclosure may be coupled together at a joining location proximate to an increased or enlarged flange section, at a joining location through an adhesive foam core, and assembly through overmolding enabled adhesive bonding, or the like.

The uncomplicated disc/spoke shape of the wheel designs described throughout the present disclosure allows for the use of segmented tools to accommodate different wheel variants with ease. Segmented tooling allows for flexibility in wheel design and sheet thickness, which enables low volume manufacturing of wheels. In a tailored die design, particular subdivisions are applied to allow economical production of different aesthetic designs as well as for technical reasons. Optionally, segmented tools can be 3D-printed from reinforced plastics with appropriate temperature stability.

### 2D. Carbon Fiber Component or Sheet on Supporting Metal Structure

In some embodiments, the CFRP-metal hybrid wheel structure of the present disclosure can be arranged in multiple ways, with the two disc-members and the rim forming sub-components that can be made from different materials. The modular concept allows for the selection of the best-fit material for each subcomponent based on its intended requirements.

As seen in FIG. 28, the bi-planar wheel structure, consisting of the rim 2804 and the two disc-members 2800/2808, is covered with a curb-side carbon disc 2820. The wheel structure in FIG. 28 can be fabricated from other semi-finished products such as forgings, castings, sheet metal, or other structural materials. In FIG. 28, the curb-side carbon disc serves as a functional wheel cover that addresses both aesthetics and aerodynamics but is not an integral part of the wheel structure.

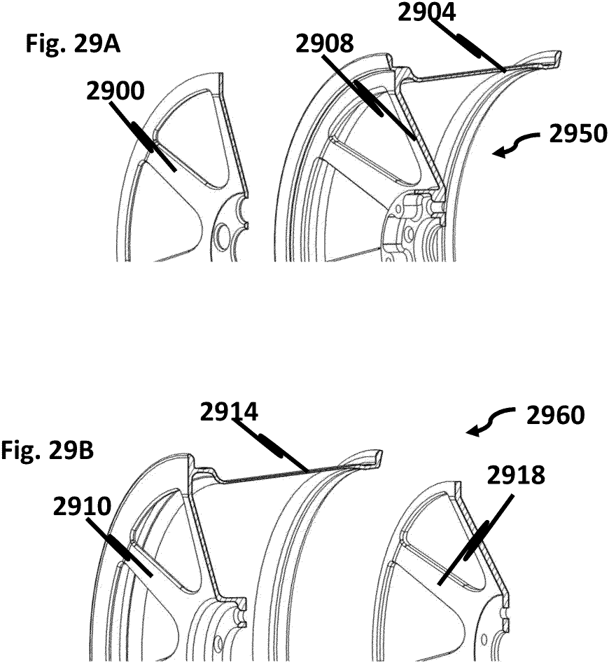

As seen in FIGS. 29A and 29B, the supporting structure for an individual carbon disc-member (2900 or 2918) can be fabricated from other semi-finished products such as forgings, castings, sheet metal, or other structural materials. For example, FIG. 29A shows a CFRP curb-side disc-member 2900 adjacent to an aluminum forged backbone 2950 integrating the rim 2904 and the vehicle side disc 2908 in one component. This arrangement is called “backbone” design. By way of another example, FIG. 29B shows a curb-side intermediate assembly 2960 made from forged aluminum integrating the rim 2914 and the curb-side side disc-member 2910 in one component. An adjacent vehicle side disc-member 2918 could be manufactured in CFRP or alternatively in other sheet material. This arrangement is called “front-bone” design. The design example in FIGS. 29A and 29B differ from the autonomous wheel cover of FIG. 28 because it integrates the curb-side disc 2900 into the wheel structure.

In some embodiments, the CFRP disc used for the frontbone, or backbone can be manufactured in two distinct ways: (a) from pre-fabricated CFRP-sheets or (b) as a layered component. The CFRP disc, when assembled with the supporting structure, provides the advantages of a modular center structure associated with the wheel structures of the present disclosure.

Specifically, one solution is when the supporting structure (backbone) is made from advanced casting. A cast backbone offers a high degree of geometric flexibility, allowing for the integration of features such as ventilation, geometry adjustments to prevent bending under compression, and mounting interfaces for wheel assembly.

In addition, advanced casting methods such as Rheocasting or squeeze casting may be utilized. These particular casting methods use lower casting temperatures, and the metal is kept in a semi-liquid state, leading to superior mechanical properties, higher ability to consume scrap, and better weldability.

In some embodiments, to support high scrap consumption during the casting of components of the wheel structure, melt conditioning is beneficial. Melt conditioning involves high-speed melt flow with high internal shear stresses in the moving metal. High-speed melt circulation can be achieved through extreme stirring or feeding the melt through a cavity with highly reduced cross-section. In general, a low number of non-metallic impurities are positive for this process.

Further, another method to realize a carbon-fiber hybrid wheel involves a manufactured backbone made from sheet metal, such as aluminum or ultra-high-strength steel. The supporting backbone structure is a deep-drawn aluminum bowl, calibrated to form the rim and inner member of the disc triangle. Forming elements are pressed into the deep metal-drawn bowl to accommodate the curb-side CFRP disc member of the triangle. In this method, the inner metal-sheet member and the curb-side CFRP member form the triangle in the wheel structure. The curb-side CFRP component can be manufactured using the methods described above. The concept is particularly beneficial for aero wheels but can applied economically as well to discs with larger cut-outs for specific aesthetic design of functionalities.

The backbone casting technology described throughout the present disclosure includes a segmented die concept to support single platform for a number of different load cases and sizes. The platform and die flexibility drive manufacturing and development cost down.

### 2E. Joining Techniques to Connect the Hybrid Wheel Components.

In some embodiments, in a fabricated wheel assembly or wheel structure, such as in a CFRP-Metal hybrid wheel, it is crucial to ensure that the components are assembled in a safe and reproducible manner. As previously mentioned, in the sections above, joining areas in a casted backbone or frontbone can be prepared in a manner that ensures the safe accommodation of the CFRP disc.

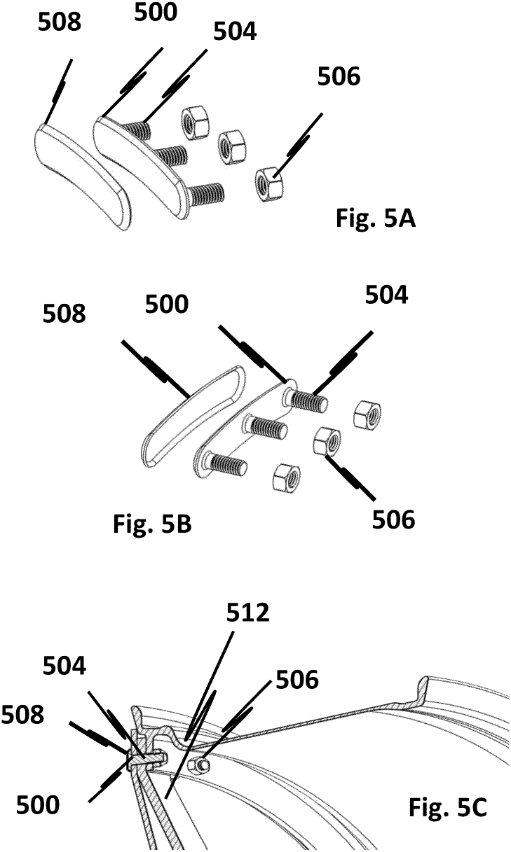

FIGS. 5A-5C illustrate a special fastening element for the wheel structures of the present invention. A fastening component consisting of an integrated backing plate with multiple screw-type fasteners is used to assemble the CFRP to a metal structure. These components are henceforth referred to as a screw plate assembly 500. For example, the screws of the screw-plate may be fastened by nuts as pictured in FIG. 5A-5B-5C.

In FIGS. 5A-5C, the screw plate assembly 500 can contain two or more threaded pins 504 that receive nuts 506 to fix the CFRP part (shown as the curb-side or outer hub assembly 508) to the metal structure (shown as the vehicle-side component 512). Depending on the design, the positions of the CFRP part and metal structures can be reversed. Alternatively to a conventional screw-nut combination, other mechanical joining principles might be applied. In some embodiments, the plate-pin material is an aluminum, such as AA7075 or AA6061. Alternatively titanium alloys may be used for the plate-pin component or any other suitable material. The screw plate can be plated with CFRP layer 508 pictured in FIG. 5A.

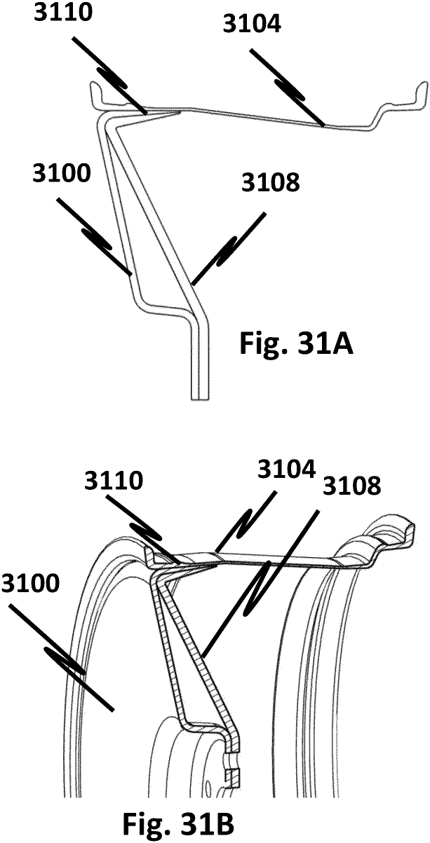

In some embodiments, the invention includes a geometry of one or more formed and flanged planar sheets to be bonded to the outer rim portion. A possible method to ensure adequate area for joining is to use a configuration similar to the one shown in FIGS. 31A and 31B. The flanges 3110 of the formed planar sheets form cylinders that are concentric with a specially prepared rim section 3104 . The flanges 3100 and 3108 can be of such a diameter that an interference fit can be produced between the two flanges as well as the rim hoop. In some embodiments, the bonding is done through adhesives but is not limited to such. Alternatively, bonding can be achieved through common thermoplastic welding techniques such as vibration welding, spin welding, electrically heated insert welding, or induction welding. The enlarged flange surface ensures safe conditions during the bonding process and under load in the field.

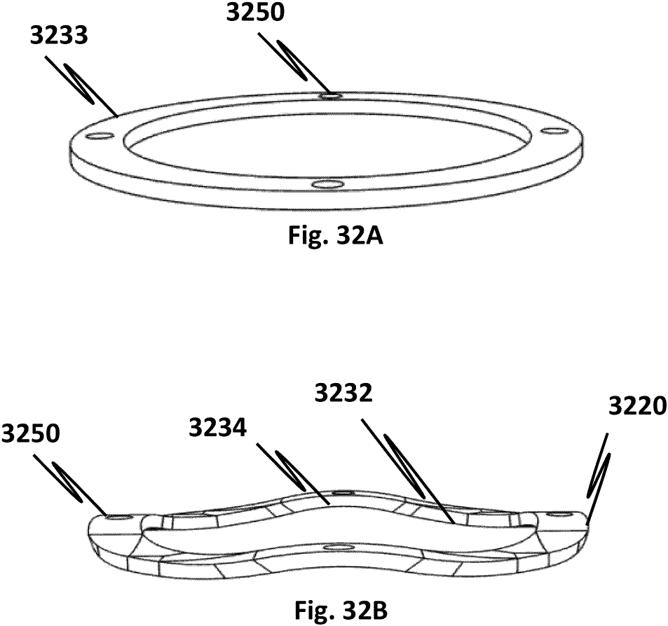

The invention includes a modulated flange geometry illustrated in FIGS. 32A and 32B to create a more even stress distribution when two components are connected with the means of screws or other mechanical fastening techniques to form the wheel assembly. When two components are connected by mechanical fasteners, especially screws, an uneven distribution of stress can occur at the interface between the two components. Typically, there is a variation in interfacial stresses along the perimeter, with the highest stress concentration at the screw connection and the lowest stress concentration between the screws.

To ensure a more even stress distribution along the perimeter of the connection, a wavy surface can be introduced as illustrated in FIG. 32B. This compensates for the impact of the screws allocated along the perimeter and helps to promote a uniform distribution of stresses. FIG. 32A illustrates a normal circular flange (3233) with localized fasteners (3250), according to prior art. In contrast, FIG. 32B depicts the typical topography of a flange with surface modulation, where the height and length of the modulation are dependent on the screw spacing and the type of material used. The invention includes a modulated flange geometry (3220) that distributes the clamp pressure distribution imparted by localized fasteners (3250) in a more homogenously over the area of contact. A more homogenous clamp pressure distribution is achieved by first establishing contact (3232) between two adjacent localized fasteners (3250). The location of the faster (3250) is raised (3234) relative to the location of first contact (3232). As the fastener is installed the flange is progressively deformed until the interfaces are parallel.

It is contemplated that the modulated flange topography can reduce the number of fasteners by 25-50%, while improving the sealing performance due to a quasi-homogenous pressure distribution. In addition, the modulated flange topography can result in an improved torque retention in metallic flanges. The improved torque retention is achieved due to two effects. First, the fastener friction is retained by the elastic function of the flange under material creep caused by local bolt pressure. Second, the fastener friction is retained by the elastic function of the flange in case of fastener loosening due to vibration or temperature cycling. Finally, warpage & spring-back mitigation is reduced because of defined contact outside of localized fasteners.

It is noted that the shape of the flange as projected onto the interface plane in FIGS. 32A and 32B does not have to be circular and can be any arbitrary shape, without departing from the scope of the present disclosure.

### 3. Special Features of Described Wheel Structures

### 3a, 3b. Wheel Rim With Improved Rigidity, via Stiffening by a Periodically Recurring Pattern in the Rim and/or Via Stiffening by a Local Sub-Structure on the Inner Wheel (Either With or Without Cavity)

In some embodiments, the wheel rim is typically a cylindrical ring accommodating the wheel tire. The ability for the rim to translate road forces to all spokes equally is proportional to the rim stiffness. Therefore, a stiffer rim is advantageous to center section of the wheel.

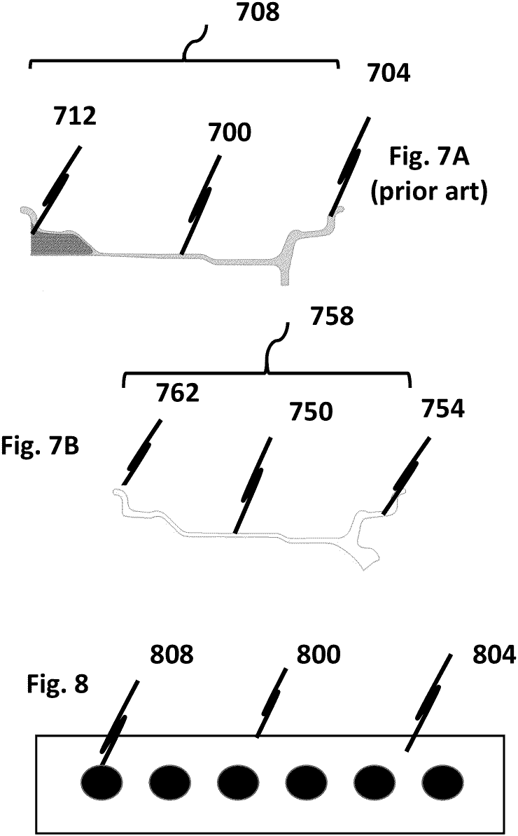

FIG. 7A depicts a conventional or prior art rim. Current wheels rely on varying section thickness/gauge to achieve the required stiffness, and consequently adds mass to the rim portion and therefore increases material cost while decreasing comfort and performance. The center piece 700 is typically far outset, located close to the curb side of the wheel 704 for aesthetic, aerodynamic and packaging reasons. That creates a long lever 708 as measured from the inboard rim flange 712. Furthermore, the absolute stiffness of the rim is inversely proportional to the length of the described lever arm. The lower the overall stiffness of the rim, the higher local rim deformations due to the weight and loading conditions of the rim in service. In effect, the rim transmits forces through localized load paths and thereby loads the wheel center unevenly. A stiffer rim allows for a lighter center section of the wheel.

In contrast, FIG. 7B depicts a wheel flange according to the present disclosure. As can be seen, the gauge of the wheel rim is substantially constant from the curb side of the wheel 754 and inboard rim flange 762 notwithstanding the long lever 758 over the center piece 750. Typically, the gauge or thickness of the flange varies typically no more than about 10% and even more typically no more than about 5% across the cross-section of the rim.

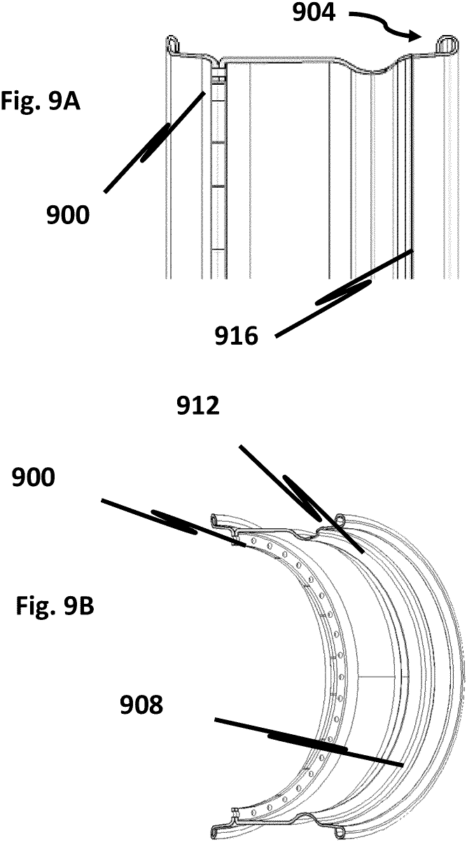

With reference to FIGS. 9A and 9B, the rim flanges are stiffened by cavities. In FIGS. 9A and 9B, the circular region of the inner rim 900 and/or the ridge 916 is stiffened by formed elements 908 and 912 respectively to form a cavity containing local sub-structure as pictured in FIG. 9A. The cavity can be realized by a porous material like foam, layered structures with geometrically supported cavities or sandwich structures where at least one material has low densities below 1 g/cm³.

The cavity-containing constituent of the rim 900 can be integrated in the component during manufacturing or applied on the finished component after or in an intermediate process.

The cavities can be in metallic or nonmetallic material. In this special solution it is made from CFRP. The cavities themselves can contain air, gas, or a lightweight material below 1 g/cm³.

The stiffening due to cavities respective open formed side-elements can be introduced in CRFP or metal sheet rims. The process of encircling the side-elements in a metal sheet is done by roll-forming, spin-forming, or a warm form flow process. The forming processes can be enhanced by heating up the respective region to be formed. Alternatively, the forming processes can be enhanced by colling (Frio-forming) up the respective region to be formed.

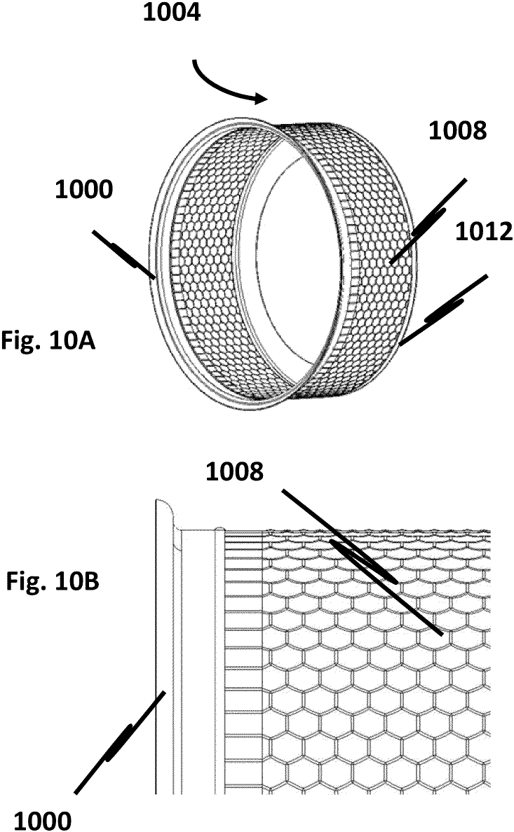

With reference to FIGS. 10A and 10B, the rim is stiffened by a periodically recurring pattern. The circular region of the inner rim 1000 reveals periodically recurring pattern 1004 of indented regions 1008 separated by raised hexagonal ridges 1012 to increase the stiffness as pictured in FIG. 10. One example pattern is a hexagonal pattern, modulating the topography of the circular rim, though other shapes can be employed. Other examples include a polygon (e.g., triangle, quadrilateral, rectangle, square, pentagon and hexagon, circle, or combination thereof. The pattern is essentially at the inner segment (brake site) of the rim and is customized for a particular rim diameter and material gauge. The pattern is introduced in the tooling for CFRP rims.

In regard to aluminum rims, the pattern can be done on a moving flat strip by embossing. The embossed hexagonal sub-structure can absorb more energy and improves crash performance because of increased rigidity.

### 3C. Wheel Structures Filled With Technical Foam / Injection Moldings

In some embodiments, the triangular openings or triangular prisms of the wheel structures of the present disclosure can be filled with structural metal foam, for example an Al-foam to stiffen the structure, prevent the inner area from catching dirt, and substantially minimize corrosion processes in small gaps and improve crash performance. For example, the void volume of the triangular prism may be at least about 50% filled with a foam. For instance, the void volume may be at least about 75% filled with a foam.

Alternatively and/or additionally, a sheet-based wheel can also be arranged in a way that the two sheets of the walls in the triangular structure meet along the length of the perimeter of the ventilation holes. This arrangement eliminates the need for ventilation hole closures as well as enhances the stiffness and crash performance of the center.

Any suitable metal foam can be used. As will be appreciated, a metal form is a cellular structure consisting of a solid base metal (frequently aluminum but can include one or more different base metals) with gas-filled pores comprising a large portion of the volume. The pores can be sealed (closed-cell foam) or interconnected (open-cell foam). The defining characteristic of metal foams is a high porosity: typically only about 5-25% of the volume is the base metal with the remainder being gas. The strength of the material is due to the square-cube law. Metal foams typically retain some physical properties of their base material. Foam made from non-flammable metal remains non-flammable and can generally be recycled as the base material. Its coefficient of thermal expansion is similar while thermal conductivity is likely reduced. It is noted the foam may be operable with a bonding adhesive or mechanical fasteners to couple wheel assembly components together.

The metal foam may be a composite metal foam. Composite Metal Foam (CMF) is made from a combination of homogeneous hollow metal spheres with a metallic matrix surrounding the spheres. This closed-cell metal foam isolates the pockets of air within and can be made out of nearly any metal, alloy, or combination. The sphere sizes can be varied and fine-tuned per application. The mixture of air-filled hollow metal spheres and a metallic matrix provides both lightweight and strength. The spheres are randomly arranged inside the material but most often resembles a simple cubic or body-centered cubic structure. CMF is made out of from about 50% to about 80% air and more typically of from about 60% to about 75%, and even more typically about 70% air. The weight reduction of the CMF is proportional to the percentage of air - as such, a CMF made out of about 70% air weighs about 70% less than an equal volume of the solid parent material.

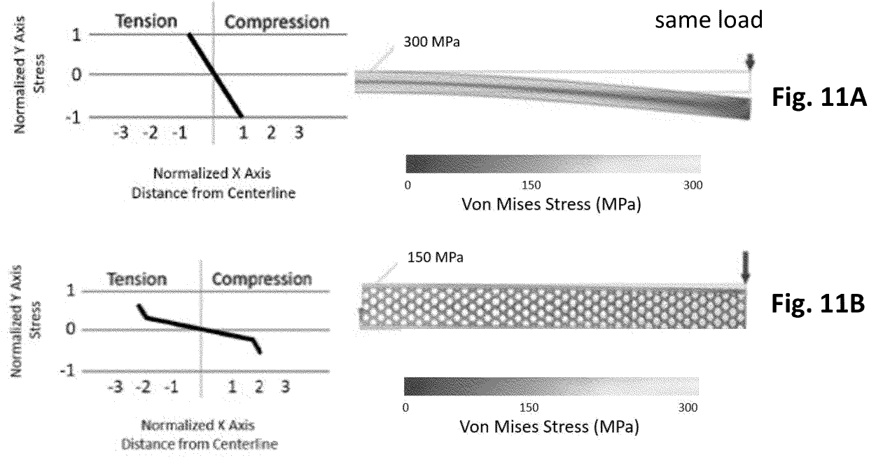

Any inner structure in the rim, such as the cavity 916 or indented regions 1008 in the pattern 1004, might be filled with an Al-foam as well as described above. In a special case, the entire rim or a significant segment of the rim comprises a hollow structure filled with foam. This sandwich structure reveals high stiffness and has a beneficial impact on the load distribution of the center disc. FIG. 11A is a plot of tension versus compression at 300 MPa, and FIG. 11B is a plot of tension versus compression at 150 MPa. The indicated stresses are based on the same load. As illustrated in FIGS. 11A and 11B, where the shaded region is aluminum foam in between 1-2 mm gauge metallic sheets in the rim illustrates the low deflection of a higher stiffness of the sandwich structure.

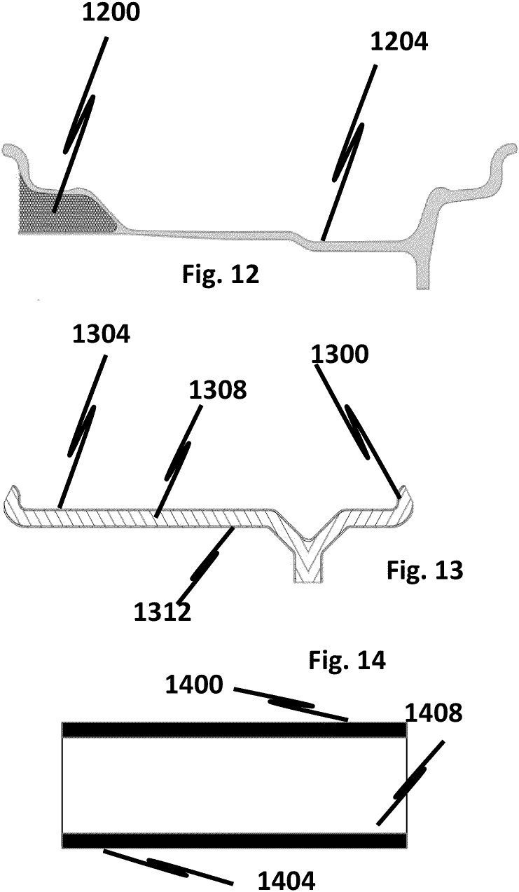

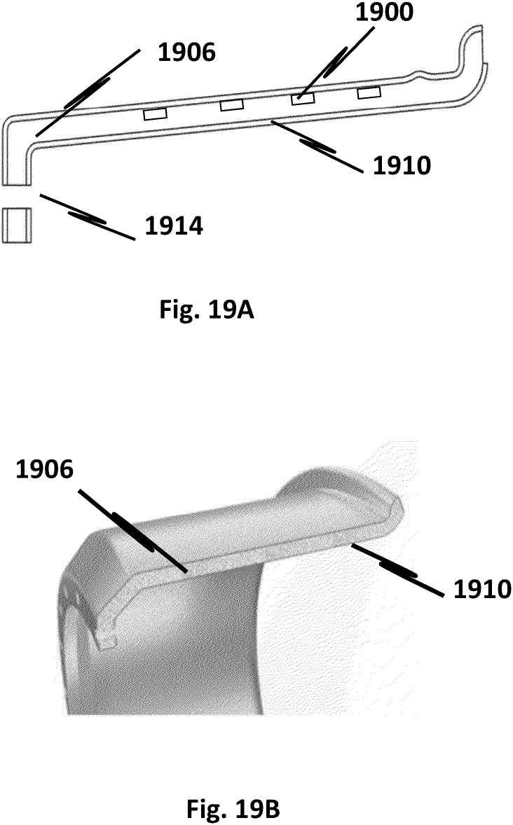

Example illustrations of a wheel structure at least partially filled with a foam are provided. FIG. 12 shows a radially disposed hollow structure 1200 substantially, if not entirely, filled with a foam in a rim 1204. The structure is located at the outer rim around the circumference of the rim 1204. FIG. 13 shows a full rim 1300 comprising foam 1308 sandwiched between metallic upper and lower surfaces 1304 and 1312. This structure is located in the rim around its circumference. As described in detail further herein. FIG. 14 illustrates the sandwich structure of FIG. 19 in more detail. A void space positioned between metallic upper and lower surfaces 1400 and 1404 is substantially, if not completely, filled with foam 1408.

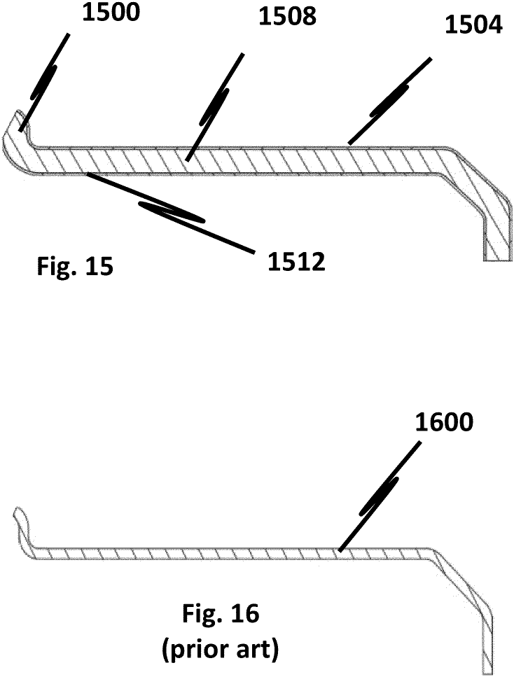

FIGS. 15 and 16 compare a rim segment 1500 according to this disclosure with a conventional rim segment 1600 according to prior art. In particular, the rim segment 1500 comprises 2 × 1 mm 6061 T6 upper and lower surfaces 1504 and 1512 separated by a10 mm AL-FOAM represented by 1508 @ 0.5 g/cm³, 3.5 kg, 0.875 g/cm³ in the intervening cavity while the rim segment 1600 comprises a standard: 4 mm 6061 T6, 2.7 g/cm³, 3.76 kg, similar to prototype ARS rims.

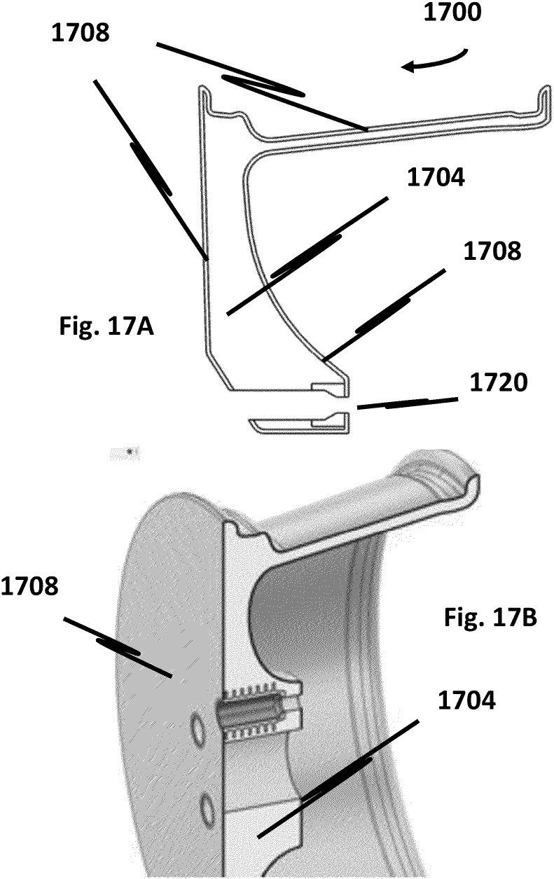

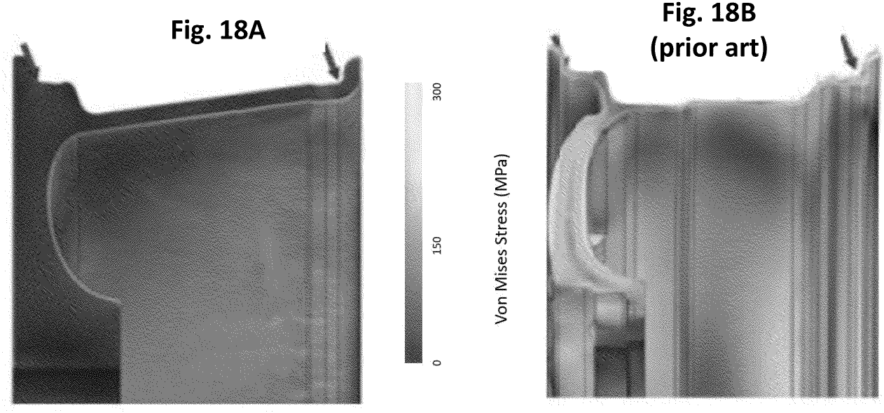

FIGS. 17A and 17B depict a full rim 1700 in a sandwich aluminum-foam design. As shown, the upper and lower surfaces 1304 and 1312 and metallic foam 1308 extend around the entire circumference of the peripheral wall 1708 of the rim 1700 and in a center section 1704 of the rim as well. FIGS. 18A and 18B show the stress distribution of a rim. In particular, FIG. 18A illustrates a stress distribution of the rim as illustrated in FIGS. 17A and 17B. In contrast, FIG. 18B illustrates a stress distribution of a conventional wheel or rim.

The manufacturing process to make the rims of the present disclosure will now be discussed with reference to FIGS. 19A and 19B. With reference to FIG. 19A, precursor pellets 1900 are positioned on a surface of the upper surface 1304 (or the lower surface 1312). The pellets 1900 can have the same or different compositions and the same or different densities, depending on the application. In one embodiment, the pellets 1900 are compressed aluminum powder and titanium hydroxide (TiH₂). The lower surface 1312 (or upper surface 1304 depending on the configuration) is then positioned adjacent and parallel to the upper surface and sealed by one or more welds 1912 to form the rim assembly 1908, which is shown in FIGS. 19A and 19B. Thermal energy or heat is then applied to the rim assembly to cause the precursor pellets to form the metallic foam 1308, which fills the inter-surface space.

### 3D. Enforced Ventilation by Fan Geometry

It is noted that brake cooling may require forced ventilation of the inner wheel area. The geometry of the disc can be engineered to support ventilation, and a fan-type geometry can be integrated into the ‘aesthetic design of the wheel.

In some embodiments, ventilation features can create an airstream either in or out of the wheel to cool the brake system. The centrifugal fan can be integrated in the inner or outer disc component which comprise the triangular structure. Alternatively, the rotor of the centrifugal fan can be formed by a component connecting the two disc components creating an airflow towards the brake. The “inter-disc” ventilation component linking the two triangle-discs can also increase the stiffness of the rim respectively wheel and helps to meet crash requirements.

The “inter-disc” ventilation component can be a part of the “backbone”, or can be integrated into a design over-molding, or might be a separate component. The separate component might be an injection molded on the disc structure before the disc is mounted on the backbone. A third option is to assemble the inter-disc vent-component between two sheet-discs by adhesive or mechanical joining methods. The inter-disc structure is beneficial to the total wheel stiffness, crash, dirt trapping and corrosion attack. Further, the ventilation element can be independent of the integral wheel structure, respectively load paths. Further, the inter-disc vent-element might be formed by injection molding building a metal plastic hybrid center of the wheel. For example, the plastic may be reinforced by glass fibers, carbon fibers, carbon flakes, graphene flakes or graphene-oxide flakes.

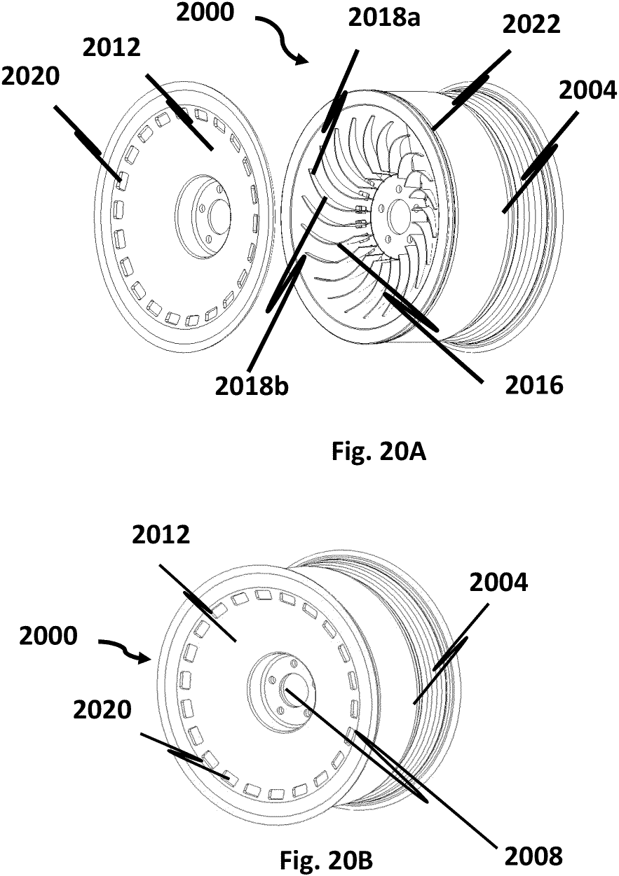

An embodiment of the ventilation feature is depicted in FIGS. 20A-B, which depict an example of a wheel assembly providing a forced air cooling disc geometry. The wheel assembly 2000 comprises a rim 2004, a hub 2008, and a decorative hub cap 2012 to cover the hub 2008. The hub 2008 provides the outer and inner disc geometry and spiral-shaped cut-outs 2016 passing through the hub to direct air flow from a curb-side or outer-side of the wheel assembly through the cut-outs 2016 and towards the vehicle-side or inner side of the wheel assembly to cool the disc brakes (not shown). Each of the cut-outs 2016 has spaced apart first and second marching arcuate or curved surfaces 2018a,b on either side of the cut-out, each representing an arc from a point near the rim edge 2022 to a point near a hub center. The hub cap 2012 comprises air flow channels 2020 passing through the hub cap 2012 and in fluid communication with the cut-outs. To enable air flow, the hub cap 2012 can be fastened to the hub 2008 in a substantially flush position, or in a position a select stand-off distance away from the hub 2008 to enable air to flow through the channels 2020 and into the cut-outs.

### 3E. Wheel Protection to Prevent Damage From Curb

For any car wheel, the most common area to sustain mechanical damage is the rim flange on the curbside. This is particularly critical for CFRP wheels, as in the case of damage to the rim flange, the entire wheel usually needs to be replaced in conventional CFRP wheels. However, while damage of the metal structure is often readily visible (e.g., a dent, a scratch, a crack, or the like), damage to a carbon structure can be less visible due to the surface appearance of carbon fiber.

To assist in preventing damage, a protection feature may be provided for the rim. The protective feature can be integrated or mounted on the wheel to protect the outer rim from scratches or serious damage. In case of damage, only the protecting feature needs to be exchanged. The feature can be a plate, closed ring, or a plurality of ring segments. The protecting module can be part of the rim, or disc or a separate part of the wheel. The protecting module can become part of the aesthetic design. A scrap resistant coating could support improve the damage tolerance of surfaces. The joining function can be combined with the protective feature as described above in the joining-technic section.

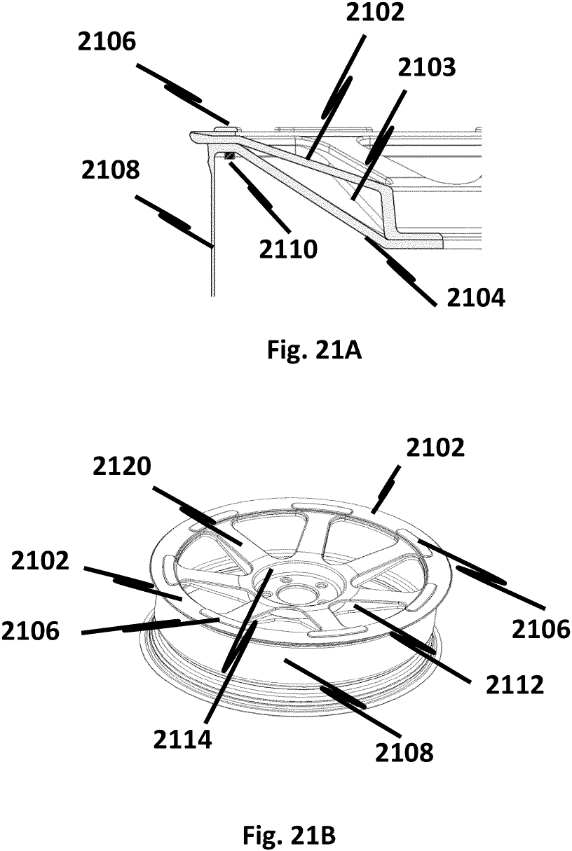

FIGS. 21A and 21B depict wheel protection in accordance with embodiments of this disclosure. With reference to FIGS. 21A and 21B, a plurality of rim protection modules 2106 in the form of pads are depicted as being removably mounted via fasteners 2110 to an inner spoke and hub assembly 2104 of a wheel assembly 2102. The rim protection modules 2106 double both as a rim protector and securing element for the inner and outer spoke and hub assemblies. The inner spoke and hub assembly 2104 connects to the rim 2108 and comprises multiple spokes 2112 emanating from a center hub member, as does the curb-side spoke and hub assembly that also comprise multiple spokes 2120 emanating from a center hub member 2114 in a pattern that is a mirror image of the inner spoke and hub assembly 2104. The rim protection modules 2106 are each located at the junction of a corresponding spoke 2120 and rim 2108. As will be appreciated, each spoke 2120 on the outer disc overlaps and is aligned with an underlying spoke 2112 of the wheel assembly 2100 to form a respective triangular prism 2103.

It is noted that the screw plate assembly 500 and protection element 2324 are also examples of protection elements to prevent damage to the rim and/or outer surfaces of the wheel assemblies described throughout the present disclosure.

### 3F. Castable Wheel With CFRP Elements

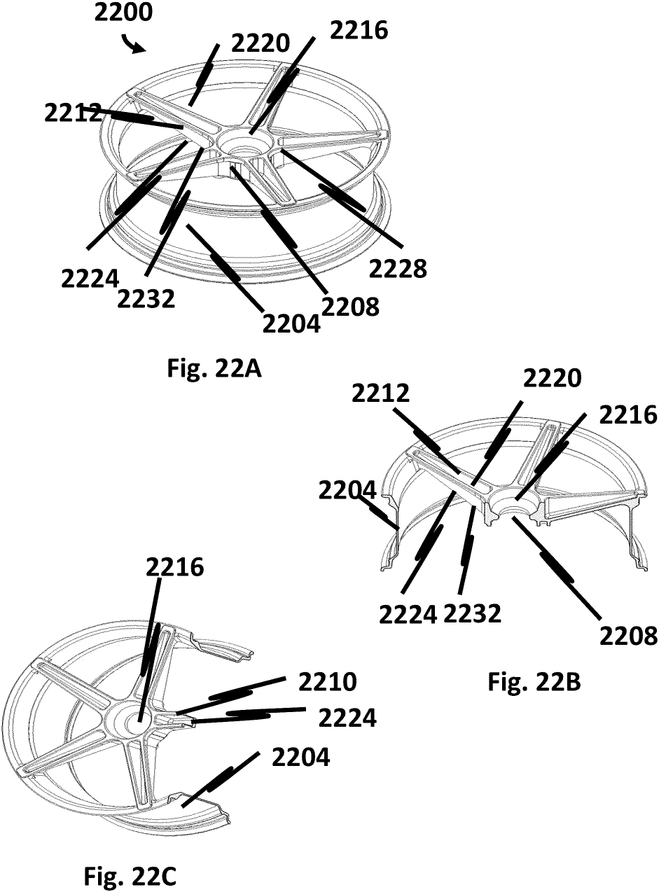

In some embodiments, the present disclosure is directed to a castable wheel as a compact wheel structure if excessive space inside the rim is required for in-wheel electric motors, (e.g., in-wheel electric motors manufactured by Elaphe or Protean, or the like). The castable wheel incorporates a triangle shape in the spoke as shown in FIGS. 22A-22C. The triangle might be supported with an I-beam geometry. The cast wheel might be one piece or alternatively the center piece containing the triangle feature. The center will be combined in a rim. In a multi-piece solution, the cast wheel can be the backbone structure for an aero wheel (such as the wheel configuration of FIGS. 20A-B), including a CFRP-prefabricated disc or a prefabricated metal sheet disc. The aerodynamic features can be over-molded with carbon fiber or glass fiber reinforced plastic.

The casting tool for the cast wheel is segmented to remove the wheel after casting. In the geometry described in FIGS. 22A-22C, the tooling can be fully permanent without any lost tooling components. Alternatively, a wheel can be casted with lost tooling by conventional casting methods.

With reference to FIGS. 22A-22C, a castable wheel assembly 2200 is depicted. The assembly 2200 comprises a rim 2204 and hub 2208, comprising plural spokes 2212 radiating from and connected to a hub center 2216. Each spoke 2212 comprises upper and lower surfaces 2220 and 2224 which together with an adjoining surface 2228 of the hub center 2216 enclose a void volume 2232 in the form of a triangular prism.

### 3G. Dirt Protection, Avoiding Trapped Dirt

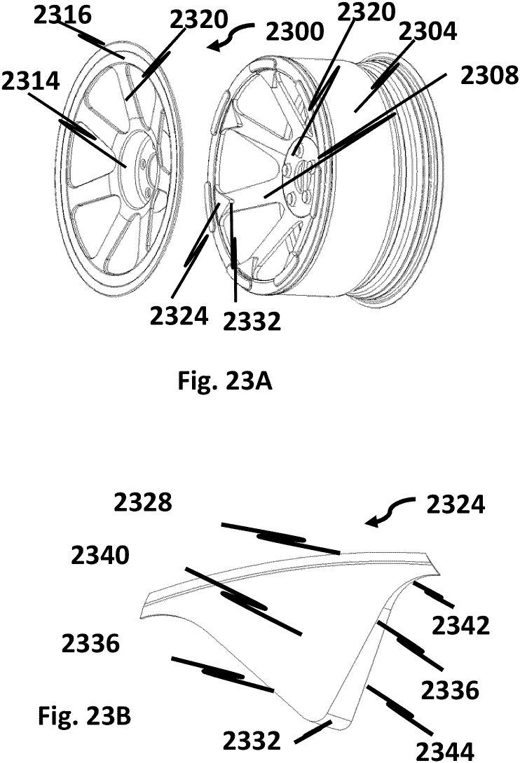

It is noted that conventional wheels can hold significant amounts of airflow-inhibiting buildup (e.g., snow, dirt, sand, and the like) that can cause temporary imbalances of the wheel assembly. In some embodiments, the wheel assemblies of the present disclosure include a protection element to fill the corner of a formed triangle and avoid entrapment of snow or debris in the narrow end of the triangle or triangular prism. The protection element, as illustrated in FIGS. 23A and 23B, is shaped so that snow and dirt is directed to the outside of the wheel center. In some embodiments, the design is comparable to a snow plow.

With reference to FIGS. 23A and 23B, a wheel assembly 2300 is depicted during assembly. The rim 2304 is attached to the inner spoke surfaces 2308 and inner hub center member 2312. A face member 2316 comprising outer spoke members 2320 attached to an outer hub center member 2314 that has a rear facing cylinder 2324 that engages the inner hub center member 2312. When engaged with each other, the outer spoke members 2320 overlap respective inner spoke members 2308 and form a respective triangular prism as discussed above. The protection element or debris inhibitor 2324 is double wedge shaped (a first wedge being viewed in plan view and second wedge inside view) and comprises a radiused pointed leading edge 2328 and much thicker trailing edge 2332 that has a pointed edge that is in a transverse plane from the leading edge. The leading edge 2328 is received at the outer edge of the triangular prism and the trailing edge is positioned along a length of the prism as shown in FIG. 23A. The outer peripheral edge 2336 of the inhibitor overlaps the outer peripheral edge of the outer and inner spoke members for aesthetic appearance. The angle 2342 formed between the upper and lower inhibitor faces 2340 and 2344 is approximately the same as the angle between the outer edge of the triangular prism. The wedge shape directs dirt and debris away from collecting in the triangular prism volume. To avoid contamination between the spokes, the vertex will be filled with an insert. Preferably the insert is integrated in the wheel center by a molding process. Typically the number of inserts is equal to the number of spokes, although a different number of inserts versus number of spokes is contemplated without departing from the scope of the present disclosure. For low volumes the inserts can be adhesively fastened to the center.

The over-molding can be applied to crevasses that result during the assembly of the wheel sub-components. Optionally this over-molding process can be combined with creating the vertex inserts.

### 3H. Vehicle-Side Spokes With Enhanced Impact Resistance

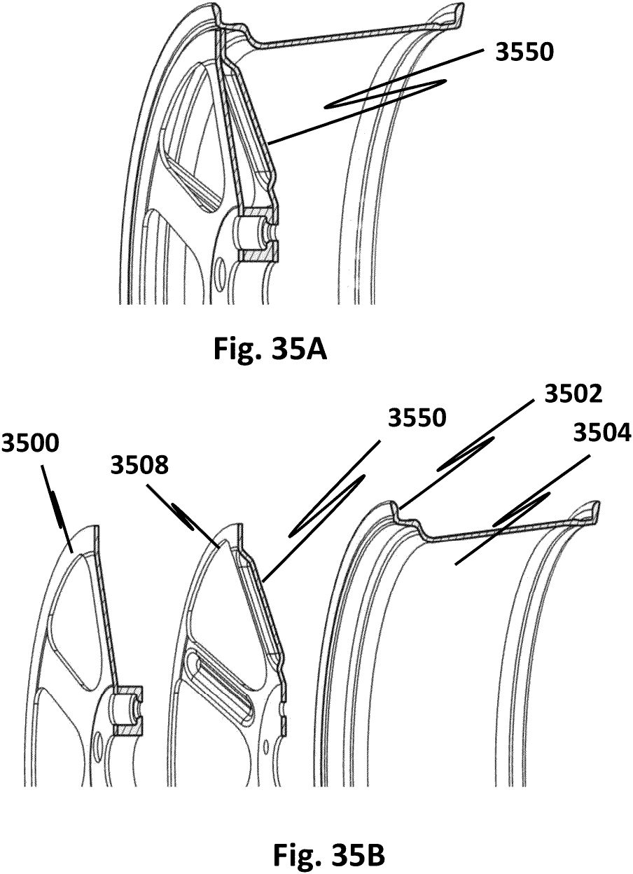

In some embodiments, vehicle-side spokes 3508 can exhibit or include forming elements or indentations 3550 as shown in FIG. 35A and FIG. 35B to improve the resistance to Euler-bending under specific crash loads that act as a compressive force on the inside spokes. The impact point is typically at the curb-side rim-flange 3502 of the rim 3504. Also shown in FIG. 35B is a curb-side disc-member 3500.

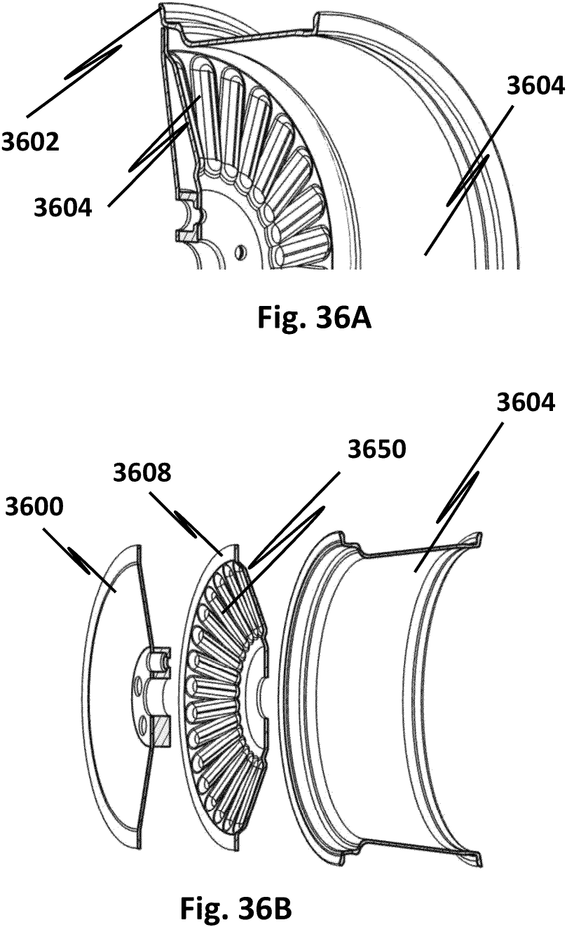

The same can be said for the vehicle-side disc 3608 in FIGS. 36A and 36B, which include radial indentations 3650 across the disc-member 3608. The curb-side member 3600 is part of the load structure and forms with the vehicle-side member the wheel center which is mounted into the rim 3604. The impact point for crash testing for wheels is typically at the rim-flange 3602.

In some embodiments, the vehicle-side spokes can deviate from a straight-line geometry in a way that shows a radius of curvature facing the outside or curbside spokes. In other words, the inner spoke is not planar along its length but has a radius of curvature (e.g., either with smooth, undulating transitions or with one or more angled corners) from the rim to the center hub of the inner disc. This can be used to improve resistance to Euler-bending under specific crash loads that act as compression on the inside spokes. This is preferably applied to material with high yield strength (e.g. UHS Steel- or high strength Al-sheet).

By these modifications of the spoke or disc geometry, a deformation path for the inside spoke is predefined, avoiding contact with the brake system or other parts in the axle system. Under specific crash loads, resistance to Euler-bending and increased energy absorption can be achieved by over-molding the inner spokes with a low density material or by contacting the inner and outer spokes with a low density material.

### 3I. Connecting Curb-Side and Vehicle-Side Structures to Enhance Impact Resistance

During a simulated impact of a curb or a pothole (e.g., as simulated in a SAE J175 lateral impact test), the failure mode of a wheel assembly of the present disclosure can be due to Euler buckling in the center discs.

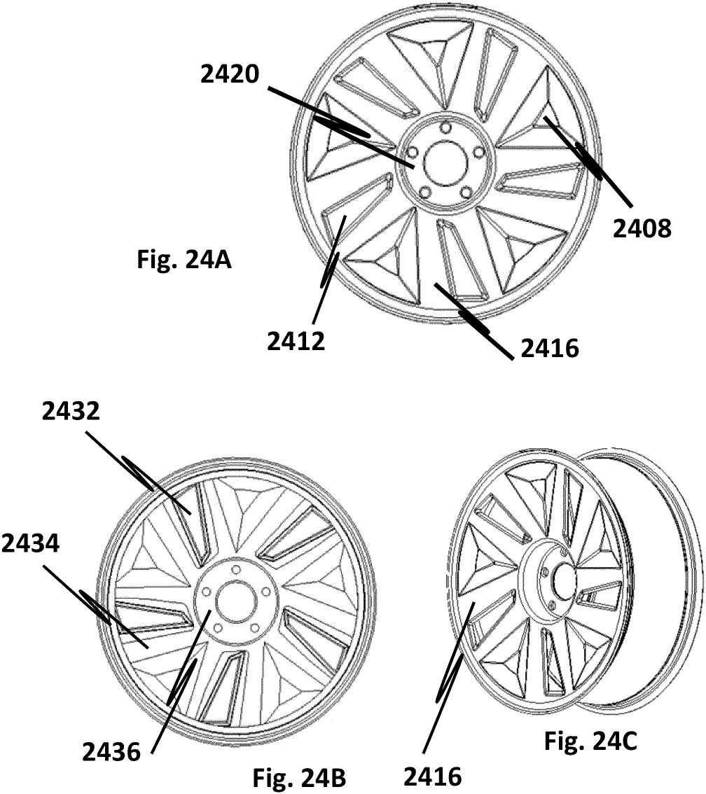

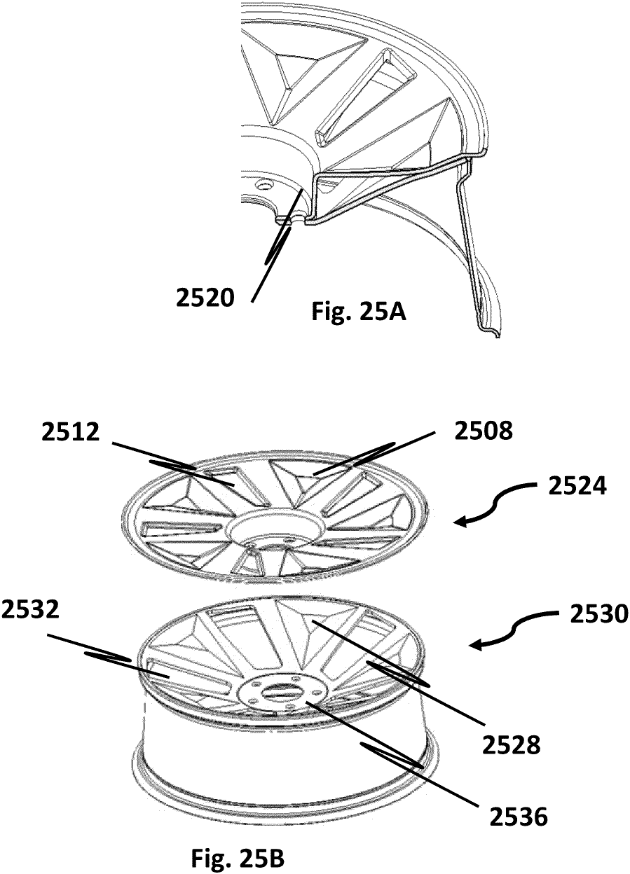

In some embodiments, an aerodynamic wheel design can combine aesthetic design features with a sheet coupling geometry between the inside and outside sheets 2508, 2528 that form the triangle structure or triangular prism of the wheel center as shown in FIGS. 24A-24C, 25A- 25B. Design features, such as triangular forming elements 2408 and rectangular or trapezoidal forming elements 2412 dividing spoke members 2416 emanating from a hub member 2420, are formed into the curbside sheet towards the inboard sheet. Respectively, design features are formed in the inboard sheet towards the curbside sheet.

In additional embodiments, the formed design features are arranged such that the two sheets make contact in between the triangle as shown in FIGS. 25A and 25B. With reference to FIGS. 25A and 25B, an outer or curb-side face member 2524 is depicted before being mounted on the intermediate wheel assembly. The intermediate wheel assembly comprises inner triangular forming elements 2528 which align with the triangular forming elements 2508 in the outer face member 2524, inner rectangular or trapezoidal cut outs 2532 which align with the rectangular or trapezoidal cut outs 2512 in the outer face member 2524, vehicle-side spoke members 2434 which align with the spokes 2416 in the outer face member 2524, and a hub member 2436 which engages the hub member 2420 in the outer face member 2524 . As shown in FIGS. 24A-C the overlapping spokes 2416 and 2434 and hub member 2520 define the profile of the wheel structure, or a radially disposed triangular prism.

The contact area between the outer face member 2524 and intermediate wheel assembly 2530 may be welded, mechanically fastened, adhesively bonded, or have a third component sandwiched in between them for NVH control (FIG. 25B). The inboard sheet on the intermediate wheel assembly may be designed such that the Euler buckling direction is predetermined towards the curbside or inboard direction for a range of impact angle variations of the SAE J175 lateral impact test.

In a similar manner a shear force transfer structure can be applied. The structure is located between to the two planes of the wheel center. One of the functions of the structure is to transfer shear forces between the two planes of the wheel center. The structure also helps to avoid collapse and/or buckling during curb impact events/testing and under road conditions.

The structure can be positioned in the center to form an I-beam cross section or close to the edges to form a boxed cross section. A boxed cross section can be furthermore filled with foam (polyurethane, etc.) or other common composite core materials (e.g., Rohacell®).

The advantage of the transfer structure can be generalized to conventional beam-spoke center wheels.

The transfer structure can be an injection overmolding component. Likewise, co-molding or separate injection molding in combination with adhesive bonding can be applied to create the transfer structure. From here on we will refer to all these technologies as overmolding.

The connection between the inner and outer spoke members can also be established by overmolding both or one of the inner and outer components with a polymer that supplies a surface for adhesively bonding the members together.

The connection between the inner and outer spoke members can also be established by overmolding both or one of the inner and outer components with a polymer that together form a cavity between the two members that can be filled and/or injected with an expanding foam. For example, a polyurethane foam with densities preferably 0.05-1.5 g/cm^3 and stiffness moduli greater than 0.05 GPa.

This concept can also be achieved via inserting and adhesively bonding a composite core For example, closed-cell polymeth -acrylimide foams, which are available from Rohacell®, such as Rohacell® IG and IG-F foams or other filler material for adhesively bonding the spoke members to the common core.

Additionally, a bonded structural core structure as well as any of the overmolding based structures described above, can take on the function of the outer hub member 2520 of the completed wheel assembly.

### 3J. Increase of Effective Limit Drawing Ratio for the Manufacture of Wheel Assemblies of the Present Disclosure

As illustrated in FIG. 25A, in some embodiments it is preferable to integrate the base of the triangle into the curbside sheet that forms one of the legs of the triangle. This can be done through various metal forming technologies. In the case of deep-drawing, it can be important to have a process and material properties that allow for a high limit drawing ratio (LDR). The effective LDR can be increased by cutting relief slots into the flange portion of the blank that will be formed to produce the curbside sheet. The relief slots prevent circumferential compressive stresses that occur as the flange is drawn into the die. The lack of compressive stresses eliminated the formation of wrinkles in the flange and reduces the tension stress in the drawn walls that could otherwise lead to fractures.

Under certain conditions it may be sufficient to omit relief slots and only employ relief holes that function as the ventilation holes of the wheel. The ventilation holes prevent circumferential compressive stresses that occur as the flange is drawn into the die. The lack of compressive stresses eliminated the formation of wrinkles in the flange and reduces the tension stress in the drawn walls that could otherwise lead to fractures. In general, relief slots or relief holes may be considered relief structures, for purposes of the present disclosure.

FIGS. 26A and 26C show a stamped/drawn curb-side outer face member 2600 without relief holes while FIGS. 26B and 26D shows a slotted and drawn curb-side or outer face member 2650 comprising spokes 2658 separated by triangular slots 2654 that provide increased LDR resistance. FIG. 26E shows an assembled wheel assembly comprising the outer face member 2650 that has an increased LDR. In each of FIGS. 26C- E, a center cylinder 2604 extends downwards with a face 2608 of the cylinder 2604 connecting to the inner hub member 2556 as shown in FIG. 25B.

### 3K. Triangular Wheel Structure With Improved Clearance for Brake Caliper

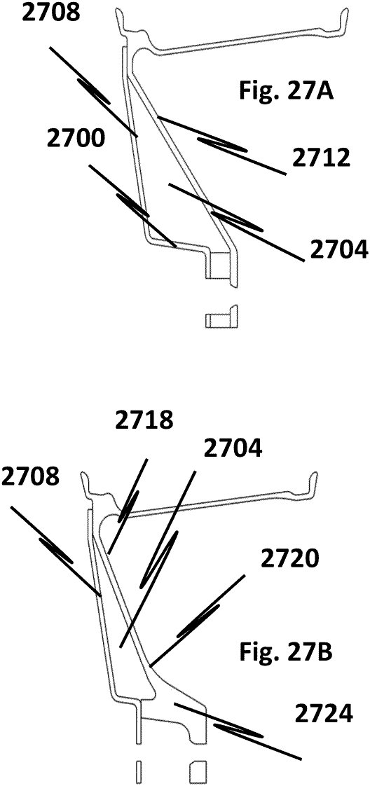

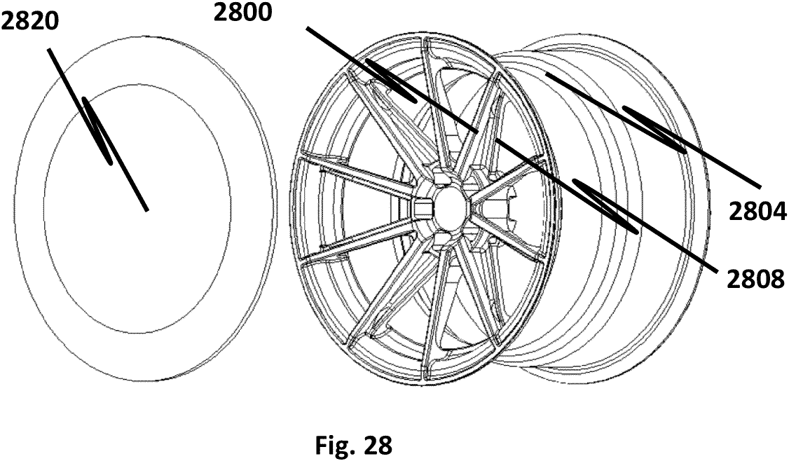

An important limitation to accomplish a superior performance/weight ratio are package constraints. Specifically, the interference of the brake caliper with the triangular wheel disc structure as pictured in FIG. 27A. In particular, in higher performance cars with large calipers having a triangular disc design can interfere with the brake package.

The key advantage in triangular disc design is the solely tension and compression load in the wheel spokes. To outline the triangular design efficiently in FIG. 27A, the base 2700 of the triangle or triangular prism 2704 (formed by outer spoke surface 2708 and inner spoke surface 2712 and base 2700) should be as large as possible. For example, a typical ratio of a 19″ wheel r/b ≈ x at a load of 750 Kg.

To give more space to a brake caliper, the leg 2716 of the triangle in FIG. 27B could have a kink or bend 2720. comprising the two legs 2718 and 2724. However, that would introduce bending forces. To avoid this, the inner leg 2724 is constructed with a geometry with infinite rigidity in relation to the forces in the outer leg 2718. The leg 2718 can be considered as “infinite stiff” if the deformation is low enough for the virtual legs of the triangle to be loaded primarily in tension and compression. FIG. 27B uses a transverse member can be employed to address the weakness caused by the kink.

### 3L. Overmolding Locking Features

In some embodiments, the overmolding elements can be designed to connect the two wheel centers or the rim to one or both of the wheel centers. The joining of the components can be done by alternative solutions. For example, snap fits are commonly used in plastic parts and can be designed to provide a secure and tight fit without the need for additional hardware such as screws or bolts. By way of another example, a wall in slot connection may be used, where when the two components are assembled, the wall fits snugly into the slot, creating a secure connection between the components. By way of another example, an overlap connection is a type of joint where two materials are overlapped and bonded together, typically using an adhesive or fastener such as screws or rivets. The strength of the joint depends on the amount of overlap and the strength of the bonding or fastening method used.

### 3M. Overmolding Aesthetic Design Options

In some embodiments, the overmolding process will be utilized to combine both wheel enhancement features and aesthetic characteristics in the load-bearing wheel structure. Wheel enhancement features can include improved load distribution, higher stiffness, improved performance, avoidance of dirt, modified airflow, and reduced drag resistance. Examples of aesthetic features include edge overmolding, modified chamfers and radii, and visual continuation of the spoke to the outer rim. It is noted that the screw plate assembly 500 and protection element 2324 are examples of an enhancement feature that is also operable as an aesthetic design.

### 3N. Wheel Bolt Lug Nut / Wheel Interface

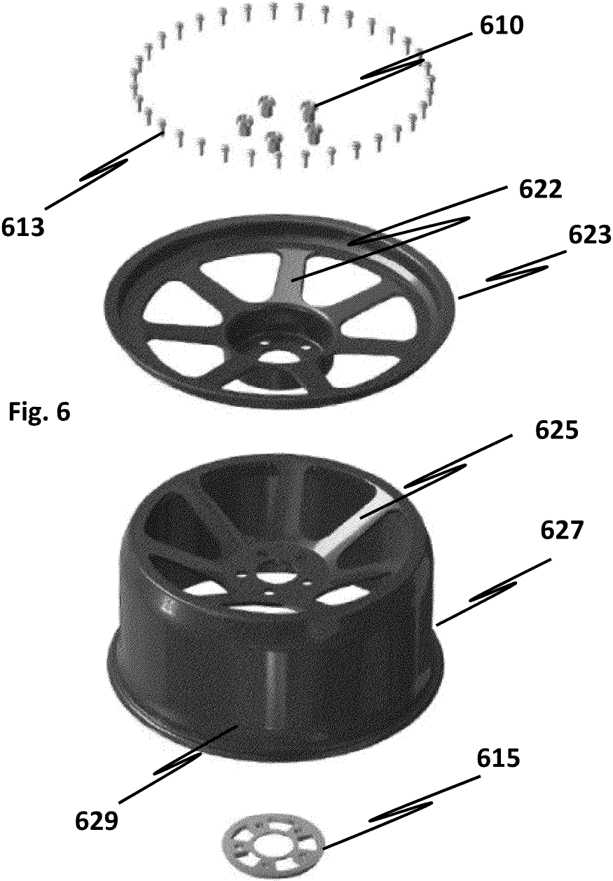

It is noted that a wheel fastener recipient (WFR) 610 as shown in FIG. 6 is necessary for securely positioning the wheel bolts. However, in most CFRP wheels, the WFR is manually positioned using a spring-ring, which is difficult to automate and can be costly. Adhesive fastening of the WFR is an alternative, but it can loosen under operating conditions such as temperature and corrosion, which can affect the aesthetic appearance of the wheel.

In some embodiments, the present invention uses insert-molding to integrate the wheel fastener recipient (WFR) securely into the wheel. This process can be easily automated and ensures a more secure fit compared to manual positioning with a spring-ring or adhesively fastening the WFR.

The wheel fastener recipients can be designed as individual components or integrated into a single structure for all wheel bolts. In cases of smaller production volumes, the WFR can be preheated before being inserted into the corresponding wheel hole for the bolts.

### 3O. Backbone and Frontbone Design

In some embodiments, the wheel assemblies include either a Backbone or a Frontbone design. The Backbone and the Frontbone design as described throughout the present disclosure is a 2-piece assembly in which one disc member (either the vehicle-side or the curb-side disc-member) is mounted in a preassembly. The preassembly is typically a one-piece intermediate component that is preferably manufactured using metal casting, forging, injection molding, or other similar manufacturing methods.

FIGS. 29A and 29B illustrate the backbone and frontbone designs, respectively. As an example for a frontbone, the vehicle side disc-member can be a CFRP-component with minor cut outs, whereas the curb side disc-member forms of narrow spokes, creating an aesthetic appearance featuring classical spoke wheels. Modern cars require wheels that can handle higher speeds, greater weight, and more demanding driving conditions. That is why classical spoke designs can be difficult to achieve using traditional wheel engineering methods, as they may not always be as strong or durable.

By utilizing two disc-members, the improved load distribution in the wheel center enables the creation of high-performance wheels that are reliable and have the classic, slender spoke appearance of the curb-side disc-member. The vehicle-side CFRP disc not only provides a high-quality appearance but also prevents the accumulation of brake dust on the front design.

An example of a backbone wheel consists of two components: an aluminum forged component that includes the rim and the vehicle-side disc member, and a curb-side CFRP disc-member as the second component. The forged backbone component ensures crash worthiness, while the CFRP curb-side member prioritizes design and low drag resistance. Together, both components form the load-bearing structure and provide the necessary stiffness. In classical wheel engineering concepts, all requirements have to be met in a single part, resulting in trade-offs being made with regard to critical requirements.

The following are examples for the division of processes used to fabricate the wheel structures of the present disclosure. The examples are provided for illustration only, and are not intended to be limiting with respect to the number of steps and/or order of performing the steps provided.

Example for 2-piece backbone hybrid wheel manufacturing flow path:
Location or step 1. Forging an aluminum billet to obtain a preform of the required geometry.
Location or step 2. The preform is milled into the backbone component, which provides the required joining features for the second component.
Location or step 3. Surface treatment and painting of the finished backbone.
Location or step 4. Manufacturing a CFRP component according to the embodiments in previous sections.
Location or step 5. Surface finishing of the CFRP component, featuring the curb-side disc-member.
Location or step 6. Mounting the CFRP component to the backbone component according to the embodiments in previous sections.

Although the above steps are described as being performed at separate locations, it is noted that one or more of the above steps may be performed at the same location, without departing from the scope of the present disclosure.

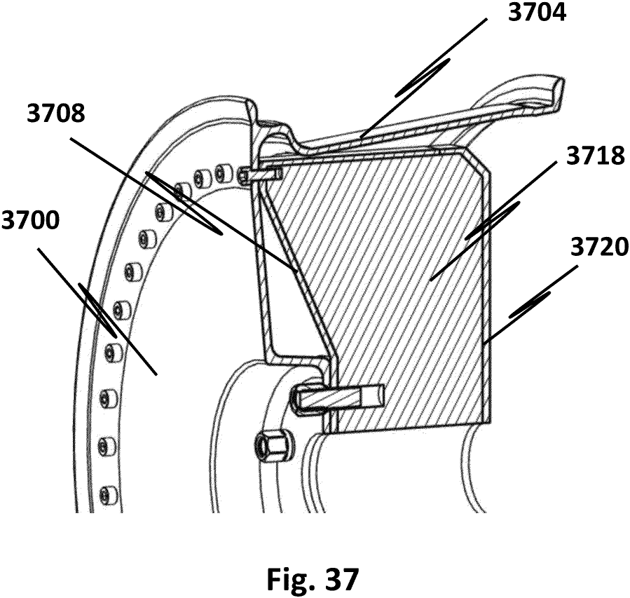

The frontbone design can be utilized as a structure for implementing an in-wheel electric motor 3718, as illustrated in FIG. 37. In this example, the vehicle-side disc-member 3708 is constructed using a portion of the in-wheel electric motor casing 3720. Unlike other in-wheel solutions for four-wheel vehicles, the casing in this design is an integral component of the load-bearing wheel center. The rim 3704 is not part of the electric motor casing, revealing the standard geometry required for tires. The curb-site member 3700 is part of the load bearing structure, supports aerodynamic requirements and is an aesthetic design element.

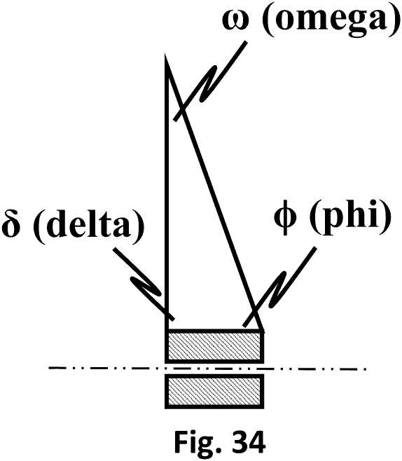

For an integrated in-wheel electric motor, a desirable option is to have a slightly convex center with the delta-triangle in FIG. 34 is δ<90° for best aerodynamic performance. Depending on the layout of the electrical motor casing the angle Φ > δ and can be as large as 90°. The triangular structure can accommodate different motor casing cross sections.

The cavity built by the curb-side member and the vehicle side member, which is a part of the wheel-electric motor casing, can be filled with a structural light weight material as described in other embodiments. The frontbone can be manufactured as CFRP, forged, or cast solution or a CFRP-metal hybrid.

The proposal describes the integration of the electric motor casing with wheel center only, a full integration into the wheel (center and rim) would cause significant drawbacks in regard to changing wheel and tires. A special layout of a two-piece wheel assembly is outlined in FIG. 6. In FIG. 6, the curb-side member 622 incorporates the curb-side part of the rim 623, and the vehicle-side member 625 incorporates the vehicle-side part of the rim 627 and together the two components build up the entire wheel. In this regard, the rim 623 is comprised of two portions, with each portion being incorporated within a respective member 623, 625. No separate rim component is thus required.

### 3P. Surface Treatment

In some embodiments, the components of the wheel assemblies described throughout the present disclosure are exposed to heat generated by the brakes, and to improve heat reflectivity, a thin film with a higher reflection factor can be applied to the surface. It is noted that a special surface treatment prevents the agglomeration of dirt, especially dust generated by the brake. For example, the surface treatment may include a grinding process, a polishing process, an applied coating 629 (e.g., as illustrated in FIG. 6), and the like).

In one non-limiting example, the coating or layer of thin film is < 20 micrometers (µm), preferably in a range from 0.1 to 2 µm. It is noted that thin coatings are less prone to cracking. The thin coating consists of a technically pure metal with high content of Al, Cu, Ni but not limited to those elements. However, the layer can also be free of either Cu, Al or Co and achieve the same results, without departing from the scope of the present disclosure. The combined atomic volume fraction of Cu + Al + Co in the layer is greater than 40. The Cu/Ag can be configured in a metallic or covalent bonding, e.g., in a metal alloy structure, intermetallic phase (IP) or metal-organic compound.

In additional non-limiting examples, the coating can consist of a layered substructure, where the single layers are a sequence of different metallic or non-metallic alloy layers or specific intermetallic particles to generate the desired finish. Specifically, the final layer might consist of an oxide or nitrite containing Cu, Al, Co eventually along with the other alloying elements. The oxide layer improves scratch and wear resistance and is chemically more stable (consistent surface appearance).

It is noted that, to improve the surface hardness and corrosion behavior and surface tension on the surface coating, the upper surface layer can be an amorphous structure, partially amorphous or nanocrystalline structure. In addition, to improve the surface hardness the upper outer surface layer can contain non-metallic dispersion like carbides, or nitrides. Further, to improve mechanical surface resistance (wear resistance), specific alloying elements are added to the Cu/Al/Ni rich base alloy. Preferably the base alloy contains elements such as Sn, Fe, P, Zn, Si, Mg, Cr, Mn, Ni, Mo, Nb, W . In the metal base of the present disclosure, up to 15% of the above alloying elements is suggested. Higher contents of the alloying elements might be beneficial, including up to 40% of Zinc (Zn). However, for high strength requirements the additions of Mo, Nb, W are more effective than Fe, Si, or Zn. Select high performance alloys may be Me-10Mo, Me-10W, Me-10Nb, Me-10W, Me-Nb9.5-W1.5 and Me-Nb10-W-4, where Me is a combination of Al, Cu and Ni. The dependency of increased strength with smaller grain size is much steeper with Nb additions. Further, organic metallic compounds or metallic salts can also be in a solution applicable to surface treatment or penetrating processes e.g., into materials with open volume.

### 3Q. Wheel Spacer

In some embodiments the wheel assemble includes a wheel center designed to distribute the high wheel load, and providing a rigid base for the triangular wheel-center configuration.

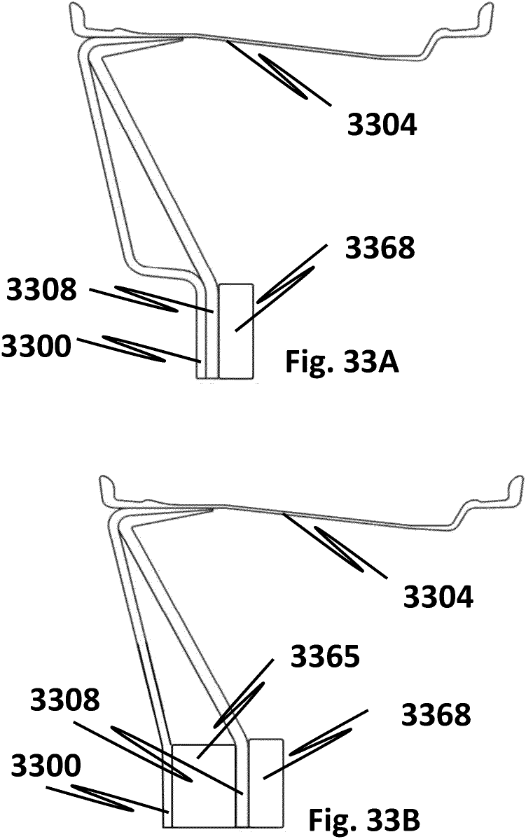

A design without a wheel spacer is shown in FIG. 33A. The component 3368 in is the hub portion of the brake disc that the wheel is fastened to. The outer disc-member 3300 typically exhibits a cup-shaped geometry in the wheel-center.

A design with a wheel spacer is shown in FIG. 33B for comparison. A wheel spacer 3365 as illustrated in FIG. 33B can be used for various purposes, such as enhancing the esthetics, improving the load distribution respectively reduces stresses in the center, or accommodating alternative manufacturing procedures. Specifically, the wheel spacer 3365 allows for a flat wheel center without the need for a cup shape or with a cup shape of reduced depth.

In other embodiments the wheel assemblies includes a wheel spacer, referred to as the “Sandwich-Base-Hub (SBH),” which is rotationally symmetrical and provides support for the two disc-members.

The Sandwich-Base-Hub (SBH) shown in FIG. 33B is composed of sections of the two disc members, 3300 and 3308, which are separated by a “spacer-element” 3365. The sandwich configuration enhances stiffness and can transfer higher forces towards the hup portion of the brake disc.

The surface-element and spacer-element can be made of the same material or different materials, such as metal, reinforced plastic (especially CFRP), or structural foam.

To prevent unwanted relative movement between the individual sandwich elements, adhesives can be used, or a high-friction intermediate layer can be employed, which may be in the form of a gel, a specialty foil, or a surface treatment. The surface treatment might be applied to one or both surfaces of adjacent sandwich elements.

The surface treatment, or intermediate agents, creates a force and form-fit micro-surface structure that prevents unfavorable low surface friction or movement at the interface. This can be accomplished by a slip-blocking ultra-hard micro-particles in the interface.

Typically, two or three sandwich-hub elements are used. However, it is possible to use more elements, such as four sandwich elements, with an additional outside spacer to aid in the mounting of the disc-members.

In a four-layer sandwich design, the curb-side wheel disc is situated between the inner spacer element 3365 and the outer spacer element (which is not shown in the drawing). This design allows for distinctive aesthetic features in the Sandwich-Base-Hub, such as a 3-dimensional OEM-brand carving. This design allows for distinctive aesthetic features in the Sandwich-Base-Hub, such as a 3-dimensional OEM-brand carving.

### 3R. Conditions of the Cross-Sectional Geometry

As described above, the wheel assemblies of the present disclosure may employ a rotationally symmetrical Sandwich-Base-Hub (SBH) that provides support for the two disc-members. To ensure the functionality of the triangular geometry, certain relationships between the two disc-members must be assured. For example, the wheel discs may form an asymmetric triangle, as illustrated in FIG. 34. In this relationship, δ (delta) > Φ (phi) > ω (omega), where δ is the curb-side angle (adjacent to the SBH) and the largest angle, Φ is the angle at the vehicle-side corner (adjacent to the SBH), and ω is the angle adjacent to the rim. The angle delta forms with the rotational wheel plane a convex geometry for δ>90° and a convex geometry for δ<90°. In some examples, delta is > 60° and <130°, preferably in the range from 70 to 115° .

Critical to the functionality of the concept is the dimension of the Sandwich-Base-Hub (SBH), the side δ is parallel to the symmetry-axis of a rotationally symmetrical Sandwich-Base-Hub. δΦ is referred as SBH-depth. The base of the SBH should have a depth of greater than 12% of the height of the triangle δω, preferably greater than 15%.

The exemplary systems and methods of this disclosure have been described in relation to inner and outer wheel structures. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, it is noted that other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for fabricating a wheel assembly, the method comprising:
forming an outer disc from a reinforced plastic, wherein the outer disc includes a first plurality of spokes;
forming an inner disc from the reinforced plastic, wherein the inner disc includes a second plurality of spokes;
forming a rim; and
forming the wheel assembly from the outer disc, the inner disc, and the rim, wherein the outer disc, the inner disc, and the rim are coupled at a first joining location, wherein the outer disc and the inner disc are coupled at a second joining location,
wherein a first spoke of the first plurality of spokes and a second spoke of the second plurality of spokes form a spoke assembly for the wheel assembly,
wherein at least a portion of a first spoke of the first plurality of spokes is set at an angle relative to at least a portion of a second spoke of the second plurality of spokes,
wherein the selected angle causes the first spoke to be substantially in contact with the second spoke at a first joining end of the spoke assembly proximate to the first joining location, and causes the first spoke to be separated a selected distance from the second spoke at a second joining end of the spoke assembly proximate to the second joining location, such that a space is formed between the at least a portion of the first spoke and the at least a portion of the second spoke, and
wherein the reinforced plastic includes a carbon fiber reinforced plastic (CFRP), a glass fiber reinforced plastic (GFRP), or a graphene flake reinforced plastic (GHFRP).

2. The method of claim 1, wherein at least one of the outer disc, the inner disc, and the rim are formed by:
providing a plurality of thermoset reinforced plastic patches;
layering the plurality of thermoset reinforced plastic patches into at least a first layer and a second layer, wherein the orientation of the thermoset reinforced plastic patches of the second layer are at a selected angle relative to the thermoset reinforced plastic patches of the first layer;
compacting the plurality of thermoset reinforced plastic patches; and
curing the compacted plurality of thermoset reinforced plastic patches, wherein:
at least one of a spoke of the first plurality of spokes of the outer disc or a spoke of the second plurality of spokes of the inner disc is formed during the layering of the plurality of thermoset reinforced plastic patches; or
at least one of a spoke of the first plurality of spokes of the outer disc or a spoke of the second plurality of spokes of the inner disc is formed following a removal of material via at least one of a trimming process or a cutting process after the curing process.

3. The method of claim 1, wherein at least one of the outer disc, the inner disc, and the rim are formed by:
providing layers of thermoplastic reinforced plastic;
consolidating the layers of thermoplastic reinforced plastic to construct a preform; and
thermoforming the preform, wherein:
at least one of a spoke of the first plurality of spokes of the outer disc or a spoke of the second plurality of spokes of the inner disc is formed during the thermoforming process, or
at least one of a spoke of the first plurality of spokes of the outer disc or a spoke of the second plurality of spokes of the inner disc is formed following a removal of material via at least one of a trimming process or a cutting process after the thermoforming process.

4. The method of claim 1, wherein the rim is formed from a metal via an extrusion process, a casting process, or a forging process.

5. The method of claim 1, wherein the wheel assembly has an increased resistance to buckling forces or Euler bending forces via one or more of:
a bow-shaped section on at least one of the first spoke of the outer disc or the second spoke of the inner disc; and
a forming element between adjacent spokes of the respective first plurality of spokes and second plurality of spokes.

6. The method of claim 1, further comprising:
performing at least one surface treatment process on the formed wheel assembly, wherein the at least one surface treatment process includes a grinding process, a polishing process, or an applying of a coating.

7. The method of claim 1, wherein the outer disc includes a first portion of a hub that is formed with the first plurality of spokes, wherein the inner disc includes a second portion of the hub that is formed with the second plurality of spokes, wherein the first portion of the hub is coupled to the second portion of the hub at the second joining location, and
wherein at least one of the first portion of the hub and the first plurality of spokes or the second portion of the hub and the second plurality of spokes are formed from a blank that includes one or more relief structures to increase limit drawing ratio (LDR) resistance.

8. The method of claim 7, further comprising:
providing a spacer; and
coupling the spacer to the hub at the second joining location, wherein the spacer is either:
positioned interior to the hub; or
positioned between the first portion of the hub and the second portion of the hub.

9. The method of claim 1, wherein the outer disc, the inner disc, and the rim are joined via at least one of:
a screw plate assembly proximate to the first joining location;
an increased or enlarged flange section formed on at least one of the outer disc and the inner disc at the first joining location;
adhesive bonding or mechanical fastening at a foam core located within the rim proximate to the first joining location and/or the second joining location; and
adhesive bonding between overmolding formed on at least one of the outer disc, the inner disc, and the rim.

10. The method of claim 1, wherein openings formed between adjacent spokes in at least one of the first plurality of spokes and the second plurality of spokes are operable as ventilation holes for the wheel assembly, and wherein the method further comprises:
coupling a debris inhibitor to at least one of the outer disc and the inner disc proximate to openings between adjacent spokes of the respective first plurality of spokes and second plurality of spokes, wherein the debris inhibitor is operable to prevent airflow-inhibiting buildup within the openings.

11. The method of claim 1, wherein at least one of the outer disc and the inner disc are formed with overmolding subcomponents that assist in the coupling of the outer disc and the inner disc, wherein the overmolding features are usable as at least one of wheel enhancement features and aesthetic design features of the wheel assembly, and wherein the method further comprises:
coupling a protection element to the outer disc at a position on an exterior surface of the outer disc, wherein the protection element is operable to prevent damage to at least one of the outer disc and the rim.

12. The method of claim 1, further comprising:
coupling a wheel fastener recipient to at least one of the outer disc and the inner disc, wherein the wheel fastener recipient is operable to position and secure lug nuts within the wheel assembly.

13. A method for fabricating a wheel assembly, the method comprising:
forming a first component for the wheel assembly from a reinforced plastic, wherein the first component includes a first plurality of spokes;
forming a second component for the wheel assembly from a metal via an extrusion process, a casting process, or a forging process, wherein the second component includes a second plurality of spokes; and
forming the wheel assembly from the first component and the second component, wherein the first component and the second component are coupled at a first joining location and a second joining location,
wherein a first spoke of the first plurality of spokes and a second spoke of the second plurality of spokes form a spoke assembly for the wheel assembly,
wherein at least a portion of a first spoke of the first plurality of spokes is set at an angle relative to at least a portion of a second spoke of the second plurality of spokes,
wherein the selected angle causes the first spoke to be substantially in contact with the second spoke at a first joining end of the spoke assembly proximate to the first joining location, and causes the first spoke to be separated a selected distance from the second spoke at a second joining end of the spoke assembly proximate to the second joining location, such that a space is formed between the at least a portion of the first spoke and the at least a portion of the second spoke, and
wherein the reinforced plastic includes a carbon fiber reinforced plastic (CFRP), a glass fiber reinforced plastic (GFRP), or a graphene flake reinforced plastic (GHFRP).

14. The method of claim 13, wherein the first component includes an outer wheel disc formed from the reinforced plastic, wherein the second component includes an integrated rim and inner wheel disc formed from the metal, and wherein the first component is coupled exterior to the second component when forming the wheel assembly.

15. The method of claim 13, wherein the first component includes an inner wheel disc formed from the reinforced plastic, wherein the second component includes an integrated rim and outer wheel disc formed from the metal, and wherein the first component is coupled interior to and within a cavity defined by the second component when forming the wheel assembly.

16. The method of claim 13, wherein the first component includes an outer wheel disc with an integrated first rim portion, wherein the second component includes an inner wheel disc within an integrated second rim portion, wherein the first component is coupled exterior to the second component when forming the wheel assembly, and wherein the first rim portion and the second rim portion form a rim for the wheel assembly when the first component is coupled to the second component.

17. The method of claim 13, wherein the first component is formed by:
providing a plurality of thermoset reinforced plastic patches;
layering the plurality of thermoset reinforced plastic patches into at least a first layer and a second layer, wherein the orientation of the thermoset reinforced plastic patches of the second layer are at a selected angle relative to the thermoset reinforced plastic patches of the first layer;
compacting the plurality of thermoset reinforced plastic patches; and
curing the compacted plurality of thermoset reinforced plastic patches, wherein:
at least one spoke of the first plurality of spokes of the first component is formed during the layering of the plurality of thermoset reinforced plastic patches, or
at least one spoke of the first plurality of spokes of the first component is formed following a removal of material via at least one of a trimming process or a cutting process after the curing process.

18. The method of claim 13, wherein the first component is formed by:
providing layers of thermoplastic reinforced plastic;
consolidating the layers of thermoplastic reinforced plastic to construct a preform; and
thermoforming the preform, wherein:
at least one spoke of the first plurality of spokes of the first component is formed during the thermoforming process, or
at least one spoke of the first plurality of spokes of the first component is formed following a removal of material via at least one of a trimming process or a cutting process after the thermoforming process.

19. The method of claim 13, wherein the wheel assembly has an increased resistance to buckling forces or Euler bending forces via one or more of:
a bow-shaped section on at least one of the first spoke of the first component or the second spoke of the second component; and
a forming element between adjacent spokes of the respective first plurality of spokes and second plurality of spokes.

20. The method of claim 13, further comprising:
performing at least one surface treatment process on the formed wheel assembly, wherein the at least one surface treatment process includes a grinding process, a polishing process, or an applying of a coating.

21. The method of claim 13, wherein the first component includes a first portion of a hub that is formed with the first plurality of spokes, wherein the second component includes a second portion of the hub that is formed with the second plurality of spokes, wherein the first portion of the hub is coupled to the second portion of the hub at the second joining location, and
wherein at least one of the first portion of the hub and the first plurality of spokes or the second portion of the hub and the second plurality of spokes are formed from a blank that includes one or more relief structures to increase limit drawing ratio (LDR) resistance.

22. The method of claim 21, further comprising:
providing a spacer; and either:
coupling the spacer to the hub at the second joining location, wherein the spacer is either:
positioned interior to the hub; or
positioned between the first portion of the hub and the second portion of the hub.

23. The method of claim 13, wherein the first component and the second component are joined via at least one of:
a screw plate assembly proximate to the first joining location;
an increased or enlarged flange section on at least one of the first component and the second component at the first joining location;
adhesive bonding or mechanical fastening at a foam core located within the second component proximate to the first joining location and/or the second joining location; and
adhesive bonding between overmolding formed on at least one of the first component and the second component.

24. The method of claim 13, wherein openings formed between adjacent spokes in at least one of the first plurality of spokes and the second plurality of spokes are operable as ventilation holes for the wheel assembly, and wherein the method further comprises:
coupling a debris inhibitor to at least one of the first component or the second component proximate to openings between adjacent spokes of the respective first plurality of spokes and second plurality of spokes, wherein the debris inhibitor is operable to prevent airflow-inhibiting buildup within the openings.

25. The method of claim 13, wherein at least one of the first component and the second component are formed with overmolding subcomponents that assist in the coupling of the first component and the second component, wherein the overmolding features are usable as at least one of wheel enhancement features and aesthetic design features of the wheel assembly, and wherein the method further comprises:
coupling a protection element to the wheel assembly, wherein the protection element is operable to prevent damage to at least one of the first component and the second component.

26. The method of claim 13, further comprising:
coupling a wheel fastener recipient to at least one of the first component and the second component, wherein the wheel fastener recipient is operable to position and secure lug nuts within the wheel assembly.

27. A method for fabricating a wheel assembly, the method comprising:
forming a first component for the wheel assembly from a reinforced plastic, wherein the first component includes a first plurality of spokes;
forming a second component for the wheel assembly from the reinforced plastic, wherein the second component includes a second plurality of spokes; and
forming the wheel assembly from the first component and the second component, wherein the first component and the second component are coupled at a first joining location and a second joining location,
wherein a first spoke of the first plurality of spokes and a second spoke of the second plurality of spokes form a spoke assembly for the wheel assembly,
wherein at least a portion of a first spoke of the first plurality of spokes is set at an angle relative to at least a portion of a second spoke of the second plurality of spokes,
wherein the selected angle causes the first spoke to be substantially in contact with the second spoke at a first joining end of the spoke assembly proximate to the first joining location, and causes the first spoke to be separated a selected distance from the second spoke at a second joining end of the spoke assembly proximate to the second joining location, such that a space is formed between the at least a portion of the first spoke and the at least a portion of the second spoke, and
wherein the reinforced plastic includes a carbon fiber reinforced plastic (CFRP), a glass fiber reinforced plastic (GFRP), or a graphene flake reinforced plastic (GHFRP).

28. The method of claim 27, wherein the first component includes an outer wheel disc formed from the reinforced plastic, wherein the second component includes an integrated rim and inner wheel disc formed from the reinforced plastic, and wherein the first component is coupled exterior to the second component when forming the wheel assembly.

29. The method of claim 27, wherein the first component includes an inner wheel disc formed from the reinforced plastic, wherein the second component includes an integrated rim and outer wheel disc formed from the reinforced plastic, and wherein the first component is coupled interior to and within a cavity defined by the second component when forming the wheel assembly.

30. The method of claim 27, wherein the first component includes an outer wheel disc with an integrated first rim portion, wherein the second component includes an inner wheel disc within an integrated second rim portion, wherein the first component is coupled exterior to the second component when forming the wheel assembly, and wherein the first rim portion and the second rim portion form a rim for the wheel assembly when the first component is coupled to the second component.

31. The method of claim 27, wherein at least one of the first component and the second component is formed by:
providing a plurality of thermoset reinforced plastic patches;
layering the plurality of thermoset reinforced plastic patches into at least a first layer and a second layer, wherein the orientation of the thermoset reinforced plastic patches of the second layer are at a selected angle relative to the thermoset reinforced plastic patches of the first layer;
compacting the plurality of thermoset reinforced plastic patches; and
curing the compacted plurality of thermoset reinforced plastic patches, wherein:
at least one spoke of the first plurality of spokes or the second plurality of spokes is formed during the layering of the plurality of thermoset reinforced plastic patches, or
at least one spoke of the first plurality of spokes or the second plurality of spokes is formed following a removal of material via at least one of a trimming process or a cutting process after the curing process.

32. The method of claim 27, wherein at least one of the first component and the second component is formed by:
providing layers of thermoplastic reinforced plastic;
consolidating the layers of thermoplastic reinforced plastic to construct a preform; and
thermoforming the preform, wherein:
at least one spoke of the first plurality of spokes or the second plurality of spokes is formed during the thermoforming process, or
at least one spoke of the first plurality of spokes or the second plurality of spokes is formed following a removal of material via at least one of a trimming process or a cutting process after the thermoforming process.

33. The method of claim 27, wherein the wheel assembly has an increased resistance to buckling forces or Euler bending forces via one or more of:
a bow-shaped section on at least one of the first spoke of the first component or the second spoke of the second component; and
a forming element between adjacent spokes of the respective first plurality of spokes and second plurality of spokes.

34. The method of claim 27, further comprising:
performing at least one surface treatment process on the formed wheel assembly, wherein the at least one surface treatment process includes a grinding process, a polishing process, or an applying of a coating.

35. The method of claim 27, wherein the first component includes a first portion of a hub that is formed with the first plurality of spokes, wherein the second component includes a second portion of the hub that is formed with the second plurality of spokes, wherein the first portion of the hub is coupled to the second portion of the hub at the second joining location, and
wherein at least one of the first portion of the hub and the first plurality of spokes or the second portion of the hub and the second plurality of spokes are formed from a blank that includes one or more relief structures to increase limit drawing ratio (LDR) resistance.

36. The method of claim 35, further comprising:
providing a spacer; and either:
coupling the spacer to the hub at the second joining location, wherein the spacer is either:
positioned interior to the hub; or
positioned between the first portion of the hub and the second portion of the hub.

37. The method of claim 27, wherein the first component and the second component are joined via at least one of:
a screw plate assembly proximate to the first joining location;
an increased or enlarged flange section on at least one of the first component and the second component at the first joining location;
adhesive bonding or mechanical fastening at a foam core located within the second component proximate to the first joining location and/or the second joining location; and
adhesive bonding between overmolding formed on at least one of the first component and the second component.

38. The method of claim 27, wherein openings formed between adjacent spokes in at least one of the first plurality of spokes and the second plurality of spokes are operable as ventilation holes for the wheel assembly, and wherein the method further comprises:
coupling a debris inhibitor to at least one of the first component or the second component proximate to openings between adjacent spokes of the respective first plurality of spokes and second plurality of spokes, wherein the debris inhibitor is operable to prevent airflow-inhibiting buildup within the openings.

39. The method of claim 27, wherein at least one of the first component and the second component are formed with overmolding subcomponents that assist in the coupling of the first component and the second component, wherein the overmolding features are usable as at least one of wheel enhancement features and aesthetic design features of the wheel assembly, and wherein the method further comprises:
coupling a protection element to the wheel assembly, wherein the protection element is operable to prevent damage to at least one of the first component and the second component.

40. The method of claim 27, further comprising:
coupling a wheel fastener recipient to at least one of the first component and the second component, wherein the wheel fastener recipient is operable to position and secure lug nuts within the wheel assembly.
